(19) United States
(12) Patent Application Publication
(10) Pub. No.: US 2025/0139110 A1
(43) Pub. Date: May 1, 2025

(54) TECHNIQUES FOR PROVIDING RELEVANT SEARCH RESULTS FOR SEARCH QUERIES

(71) Applicant: Apple Inc., Cupertino, CA (US)

(72) Inventors: Santosh SHANKAR, Santa Clara, CA (US); Deepak MURALIDHARAN, Boston, MA (US); Donald M. DINI, Sunnyvale, CA (US); Kevin CHITTINAPPILY SEBASTIAN, Fremont, CA (US); Kushal Subhash TAYAL, Santa Clara, CA (US); Sean SUCHTER, Los Altos Hills, CA (US)

(21) Appl. No.: 18/903,964

(22) Filed: Oct. 1, 2024

Related U.S. Application Data
(60) Provisional application No. 63/657,844, filed on Jun. 8, 2024.
(60) Provisional application No. 63/594,864, filed on Oct. 31, 2023.

(51) Int. Cl. G06F 16/248; G06F 16/2452

(52) U.S. Cl. CPC G06F 16/248; G06F 16/24522

(57) ABSTRACT

Disclosed herein are techniques for providing relevant results for search queries. For example, a method implemented by a server computing device can include the steps of (1) receiving an unstructured query from a client computing device, (2) providing the unstructured query to a first large language model (LLM) to produce a plurality of structured queries, (3) for each structured query of the plurality of structured queries: (i) identifying, based on at least one aspect of the structured query, respective one or more knowledge sources to produce respective results for the structured query, and (ii) providing the structured query to the respective one or more knowledge sources to produce the respective results, (4) aggregating the results to produce aggregated results, (5) providing the aggregated results to a second LLM to produce filtered results, and (6) causing the client computing device to display at least a portion of the filtered results.

### CROSS-REFERENCE TO RELATED APPLICATIONS

The present application claims the benefit of U.S. Provisional Application No. 63/657,844, entitled “TECHNIQUES FOR PROVIDING RELEVANT SEARCH RESULTS FOR SEARCH QUERIES,” filed Jun. 8, 2024 and U.S. Provisional Application No. 63/594,864, filed Oct. 31, 2023, of the same title, the contents of all of which are incorporated by reference herein in their entirety for all purposes.

### FIELD

The described embodiments relate generally to implementing search algorithms. More particularly, the described embodiments provide techniques for implementing search algorithms that generate relevant search results for search queries.

### BACKGROUND

Returning relevant search results to users based on their search queries can be a complex endeavor. In particular, returning relevant search results requires a sophisticated understanding of users' intent as well as efficiently accessing and utilizing the vast amount of information that is available (e.g., through the Internet). This can be challenging, however, for at least the following reasons.

First, the inherent ambiguity in search queries presents a significant challenge. In particular, users often express their informational needs in imprecise or vague terms, making it challenging for search engines to accurately interpret the users' intent. For example, a user searching for “java” could be looking for information about the island of Java in Indonesia, Java coffee, or the programming language Java®. Despite these challenges, deciphering users' intent remains a crucial aspect in providing relevant search results to them.

Second, the sheer volume of data that is accessible to search engines-such as through the Internet, through locally-accessible data sets, etc.—can be overwhelming. For example, search engines must crawl and index an immense number of web pages, and this vastness of information makes it challenging to ensure that all relevant data is considered when providing search results. Additionally, it is resource-intensive to keep these indexes up to date relative to the constantly-changing landscape of the Internet.

Third, language and cultural nuances can often add another layer of complexity. In particular, search engines must consider regional language variations, idiomatic expressions, and cultural differences to provide search results to users that are relevant and contextual to their locales. This can be problematic, however, as the meaning of a commonly used search term in one region could be entirely different in another, thereby leading to potential misinterpretations and inaccurate/irrelevant search results.

Additionally, personalization plays a crucial role in search results, but it also introduces challenges. In particular, a given search engine may aim to provide results that are tailored to a given user's individual preferences, search history, and so on. However, striking the right balance between personalization, diversity, and privacy considerations can be difficult. For example, a search engine that overemphasizes the user's search history may generate results that are highly specific to the user even when the user is only seeking a generic response to their inquiry. Conversely, a search engine that disregards the user's search history may generate search results that are highly generic to the user despite the user's desire to obtain more personalized search results.

In conclusion, the difficulty of returning relevant search results to users based on their search inputs arises from the ambiguity of search queries, the vastness of available information, language and cultural nuances, the complexities of personalization (while respecting privacy), and the ever-evolving nature of search engine algorithms. Addressing these challenges requires a combination of advanced technology, ongoing research, and a deep understanding of user behavior and intent in order to continually improve the search experiences for users.

Accordingly, what is needed is an improved technique for providing relevant search results to users in response to their search queries.

### SUMMARY

The described embodiments relate generally to implementing search algorithms. More particularly, the described embodiments provide techniques for implementing search algorithms that generate relevant search results for search queries.

One embodiment sets forth a method for providing relevant results for unstructured queries. According to some embodiments, the method can be implemented at a server computing device, and includes the steps of (1) receiving an unstructured query from a client computing device, (2) providing the unstructured query to a first large language model (LLM) to produce a plurality of structured queries, (3) for each structured query of the plurality of structured queries: (i) identifying, based on at least one aspect of the structured query, respective one or more knowledge sources to produce respective results for the structured query, and (ii) providing the structured query to the respective one or more knowledge sources to produce the respective results, (4) aggregating the results to produce aggregated results, (5) providing the aggregated results to a second LLM to produce filtered results, and (6) causing the client computing device to display at least a portion of the filtered results.

Another embodiment sets forth another method for providing relevant results for unstructured queries. According to some embodiments, the method can be implemented at a server computing device, and includes the steps of (1) receiving an unstructured query from a client computing device, (2) providing the unstructured query to a first large language model (LLM) to produce a query understanding object, where the query understanding object includes a plurality of tasks, and each task of the plurality of tasks includes a respective category and respective one or more properties, (3) for each task of the plurality of tasks: (i) identifying, based on the respective category and the respective one or more properties, respective one or more knowledge sources to produce respective results for the task, and (ii) providing the task to the respective one or more knowledge sources to produce the respective results, (4) aggregating the results to produce aggregated results, (5) providing the aggregated results to a second LLM to produce filtered results, and (6) causing the client computing device to display at least a portion of the filtered results.

Another embodiment sets forth a method for an application to obtain query results based on search queries. According to some embodiments, the method can be implemented by an application executing on a client computing device, and includes the steps of (1) obtaining an unstructured query from a user of the client computing device, (2) in response to obtaining the unstructured query, providing the unstructured query to an operating system (OS) executing on the client computing device, (3) in response to providing the unstructured query to the OS, receiving filtered results associated with the unstructured query, where: a first large language model (LLM) produces a plurality of structured queries based on the unstructured query, each structured query of the plurality of structured queries is provided to respective one or more knowledge sources that are selected based on at least one aspect of the structured query and provide respective results, and the results are aggregated and filtered by a second LLM to generate the filtered results, and (4) in response to receiving the filtered results, performing at least one action associated with the filtered results.

Another embodiment sets forth a method for an application to obtain query results based on search queries. According to some embodiments, the method can be implemented by an application executing on a client computing device, and includes the steps of (1) in response to providing an unstructured query to an operating system (OS) executing on the client computing device, obtaining filtered results, where the filtered results include, for each result of the filtered results, a respective explanation as to why the result is relevant to the unstructured query, and (2) generating a user interface that displays, for at least one result of the filtered results, (i) at least one first affordance that includes information associated with the result, and (ii) at least one second affordance that, when selected, causes the application to display the respective explanation.

Yet another embodiment sets forth a method for an application to obtain query results based on search queries. According to some embodiments, the method can be implemented by an application executing on a client computing device, and includes the steps of (1) obtaining an unstructured query from a user of the client computing device, (2) in response to obtaining the unstructured query, providing the unstructured query to an operating system (OS) executing on the client computing device, (3) in response to providing the unstructured query to the OS, receiving filtered results associated with the unstructured query, where: the filtered results are generated using a first large language model (LLM) that produces a query understanding object, where the query understanding object includes a plurality of tasks, and each task of the plurality of tasks includes a respective category and respective one or more properties, each task of the plurality of tasks is (i) used to identify, based on the respective category and the respective one or more properties, respective one or more knowledge sources to produce respective results for the task, and (ii) provided to the respective one or more knowledge sources to produce the respective results, and the results are aggregated and filtered by a second LLM to produce filtered results, and (4) in response to receiving the filtered results, performing at least one action associated with the filtered results.

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1A illustrates an application process for interacting with a system.

FIG. 1B illustrates an application process for interacting with a system.

FIG. 1C illustrates software architecture of a device that includes Application Programming Interface (API) calling instructions.

FIG. 1D illustrates software architecture of a system that includes an API and implementation instructions.

FIG. 1E illustrates an application process for interacting with a system using API calling instructions.

FIG. 1F illustrates an application process for interacting with a system using API calling instructions.

FIG. 1G illustrates a block diagram of different components of a system that can be configured to implement the various techniques described herein, according to some embodiments.

FIGS. 2A-2K illustrate conceptual diagrams of an example sequence of interactions between various entities described in conjunction with FIG. 1G, according to some embodiments.

FIG. 2L illustrates a conceptual diagram of example user interfaces that can be provided by a client computing device in conjunction with carrying out the steps described in conjunction with FIGS. 2A-2K, according to some embodiments.

FIGS. 2M-2N illustrate a method for generating query results based on search queries 104, according to some embodiments.

FIGS. 3A-3I illustrate conceptual diagrams of another example sequence of interactions between various entities described in conjunction with FIG. 1G, according to some embodiments.

FIG. 3J illustrates a conceptual diagram of example user interfaces that can be provided by a client computing device in conjunction with carrying out the steps described in conjunction with FIGS. 3A-3I, according to some embodiments.

FIGS. 3K-3L illustrate a method for an alternative approach for generating query results based on search queries, according to some embodiments.

FIG. 3M illustrates a conceptual diagram of example user interfaces that can be provided by a client computing device in conjunction with carrying out the steps described in conjunction with FIGS. 3K-3L, according to some embodiments.

FIGS. 4A, 4B, and 5 illustrate methods for applications to obtain query results based on search queries, according to some embodiments.

FIG. 6 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

The described embodiments relate generally to implementing search algorithms. More particularly, the described embodiments provide techniques for implementing search algorithms that generate relevant search results for search queries.

Implementations and techniques within the scope of the present disclosure can be partially or entirely realized using a tangible computer-readable storage medium (or multiple tangible computer-readable storage media of one or more types) encoding one or more computer-readable instructions. It should be recognized that computer-executable instructions can be organized in any format, including applications, application extensions, widgets, processes, software, software modules, and/or components.

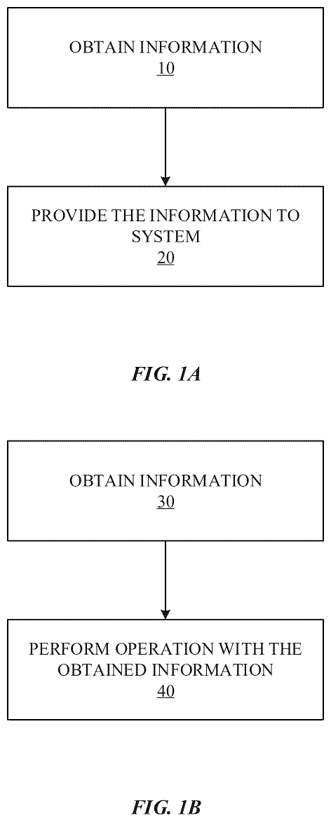

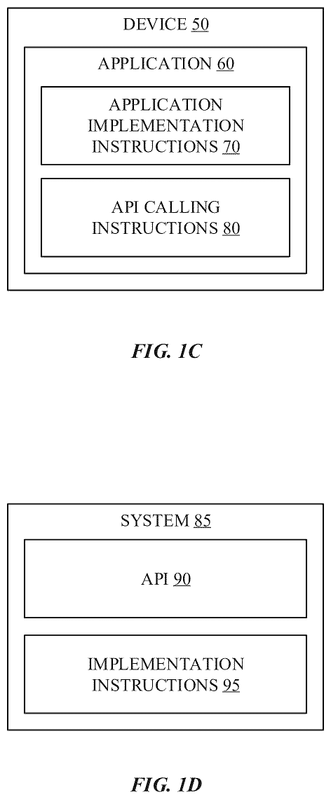

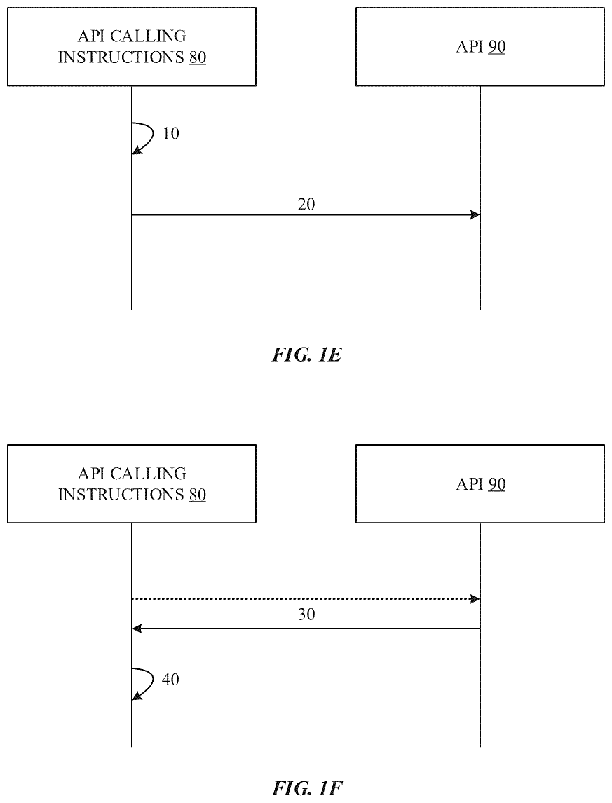

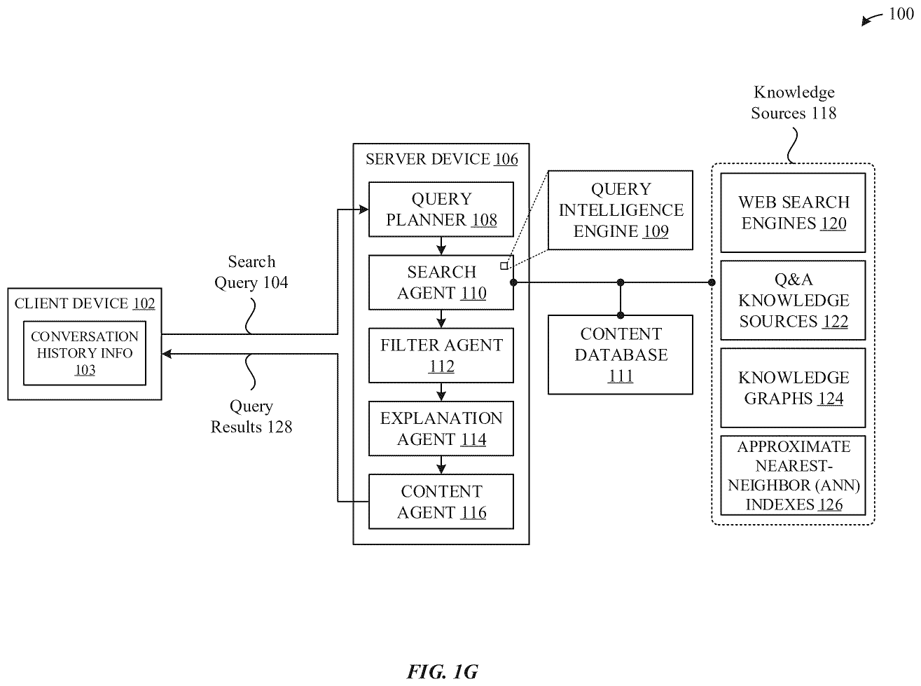

Implementations within the scope of the present disclosure include a computer-readable storage medium that encodes instructions organized as an application (e.g., application 60) that, when executed by one or more processing units, control an electronic device (e.g., device 50) to perform the method of FIG. 1A, the method of FIG. 1B, and/or one or more other processes and/or methods described herein.

It should be recognized that application 60 (shown in FIG. 1D) can be any suitable type of application, including, for example, one or more of: a browser application, an application that functions as an execution environment for plug-ins, widgets or other applications, a search application, fitness application, a health application, a digital payments application, a media application, a social network application, a messaging application, and/or a maps application. In some embodiments, application 60 is an application that is pre-installed on device 50 at purchase (e.g., a first party application). In other embodiments, application 60 is an application that is provided to device 50 via an operating system update file (e.g., a first party application or a second party application). In other embodiments, application 60 is an application that is provided via an application store. In some embodiments, the application store can be an application store that is pre-installed on device 50 at purchase (e.g., a first party application store). In other embodiments, the application store is a third-party application store (e.g., an application store that is provided by another application store, downloaded via a network, and/or read from a storage device).

Referring to FIG. 1A and FIG. 1E, application 60 obtains information (e.g., step 10). In some embodiments, at step 10, information is obtained from at least one hardware component of the device 50. In some embodiments, at step 10, information is obtained from at least one software module (e.g., set of instructions) of the device 50. In some embodiments, at step 10, information is obtained from at least one hardware component external to the device 50 (e.g., a peripheral device, an accessory device, a server, etc.). In some embodiments, the information obtained at step 10 includes positional information, time information, notification information, user information, environment information, electronic device state information, weather information, media information, historical information, event information, hardware information, and/or motion information. In some embodiments, in response to and/or after obtaining the information at step 10, application 60 provides the information to a system (e.g., step 20).

In some embodiments, the system (e.g., 85 shown in FIG. 1D) is an operating system hosted on the device 50. In some embodiments, the system (e.g., 85 shown in FIG. 1D) is an external device (e.g., a server, a peripheral device, an accessory, a personal computing device, etc.) that includes an operating system.

Referring to FIG. 1B and FIG. 1F, application 60 obtains information (e.g., step 30). In some embodiments, the information obtained at step 30 includes search information, positional information, time information, notification information, user information, environment information electronic device state information, weather information, media information, historical information, event information, hardware information and/or motion information. In response to and/or after obtaining the information at step 30, application 60 performs an operation with the information (e.g., step 40). In some embodiments, the operation performed at step 40 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 85 based on the information.

In some embodiments, one or more steps of the method of FIG. 1A and/or the method of FIG. 1B is performed in response to a trigger. In some embodiments, the trigger includes detection of an event, a notification received from system 85, a user input, and/or a response to a call to an API provided by system 85.

In some embodiments, the instructions of application 60, when executed, control device 50 to perform the method of FIG. 1A and/or the method of FIG. 1B by calling an application programming interface (API) (e.g., API 90) provided by system 85. In some embodiments, application 60 performs at least a portion of the method of FIG. 1A and/or the method of FIG. 1B without calling API 90.

In some embodiments, one or more steps of the method of FIG. 1A and/or the method of FIG. 1B includes calling an API (e.g., API 90) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 1C, device 50 is illustrated. In some embodiments, device 50 is a personal computing device, a smart phone, a smart watch, a fitness tracker, a head mounted display (HMD) device, a media device, a communal device, a speaker, a television, and/or a tablet. As illustrated in FIG. 1C, device 50 includes application 60 and an operating system (not shown). Application 60 includes application implementation instructions 70 and API calling instructions 80. System 85 includes API 90 and implementation instructions 95. It should be recognized that device 50, application 60, and/or system 85 can include more, fewer, and/or different components than illustrated in FIGS. 1C and 1D.

In some embodiments, application implementation instructions 70 is a software module that includes a set of one or more computer-executable instructions. In some embodiments, the set of one or more instructions of instructions 70 correspond to one or more operations performed by application 60. For example, when application 60 is a messaging application, application implementation instructions 70 can include operations to receive and send messages. In another example, when application 60 is a search application, application implementation instructions can include operations to process search requests, which includes generating responses that include relevant results for the search requests. In some embodiments, application implementation instructions 70 communicates with API calling instructions to communicate with system 85 via API 90 (shown in FIG. 1D).

In some embodiments, API-calling instructions 80 is a software module that includes a set of one or more computer-executable instructions.

In some embodiments, implementation instructions 95 is a software module that includes a set of one or more computer-executable instructions.

In some embodiments, API 90 is a software module that includes a set of one or more computer-executable instructions. In some embodiments, API 90 provides an interface that allows a different set of instructions (e.g., API calling instructions 80) to access and/or use one or more functions, methods, procedures, data structures, classes, and/or other services provided by implementation instructions 95 of system 85. For example, API-calling instructions 80 can access a feature of implementation instructions 95 through one or more API calls or invocations (e.g., embodied by a function or a method call) exposed by API 90 and can pass data and/or control information using one or more parameters via the API calls or invocations. In some embodiments, API 90 allows application 60 to use a service provided by a Software Development Kit (SDK) library. In other embodiments, application 60 incorporates a call to a function or method provided by the SDK library and provided by API 90 or uses data types or objects defined in the SDK library and provided by API 90. In some embodiments, API-calling instructions 80 makes an API call via API 90 to access and use a feature of implementation instructions 95 that is specified by API 90. In such embodiments, implementation instructions 95 can return a value via API 90 to API-calling instructions 80 in response to the API call. The value can report to application 60 the capabilities or state of a hardware component of device 50, including those related to aspects such as input capabilities and state, output capabilities and state, processing capability, power state, storage capacity and state, and/or communications capability. In some embodiments, API 90 is implemented in part by firmware, microcode, or other low level logic that executes in part on the hardware component.

In some embodiments, API 90 allows a developer of API-calling instructions 80 (which can be a third-party developer) to leverage a feature provided by implementation instructions 95. In such embodiments, there can be one or more set of API-calling instructions (e.g., including API-calling instructions 80) that communicate with implementation instructions 95. In some embodiments, API 90 allows multiple sets of API-calling instructions written in different programming languages to communicate with implementation instructions 95 (e.g., API 90 can include features for translating calls and returns between implementation instructions 95 and API-calling instructions 80) while API 90 is implemented in terms of a specific programming language. In some embodiments, API-calling instructions 80 calls APIs from different providers such as a set of APIs from an OS provider, another set of APIs from a plug-in provider, and/or another set of APIs from another provider (e.g., the provider of a software library) or creator of the another set of APIs.

Examples of API 90 can include one or more of: a search API (e.g., for generating search results based on search queries), a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments the sensor API is an API for accessing data associated with a sensor of device 50. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor and/or biometric sensor.

In some embodiments, implementation instructions 95 is a system (e.g., operating system, server system) software module (e.g., a collection of computer-readable instructions) that is constructed to perform an operation in response to receiving an API call via API 90. In some embodiments, implementation instructions 95 is constructed to provide an API response (via API 90) as a result of processing an API call. By way of example, implementation instructions 95 and API-calling instructions 80 can each be any one of an operating system, a library, a device driver, an API, an application program, or other module. It should be understood that implementation instructions 95 and API-calling instructions 80 can be the same or different type of software module from each other. In some embodiments, implementation instructions 95 is embodied at least in part in firmware, microcode, or other hardware logic.

In some embodiments, implementation instructions 95 returns a value through API 90 in response to an API call from API-calling instructions 80. While API 90 defines the syntax and result of an API call (e.g., how to invoke the API call and what the API call does), API 90 might not reveal how implementation instructions 95 accomplishes the function specified by the API call. Various API calls are transferred via the one or more application programming interfaces between API-calling instructions 80 and implementation instructions 95. Transferring the API calls can include issuing, initiating, invoking, calling, receiving, returning, and/or responding to the function calls or messages. In other words, transferring can describe actions by either of API-calling instructions 80 or implementation instructions 95. In some embodiments, a function call or other invocation of API 90 sends and/or receives one or more parameters through a parameter list or other structure.

In some embodiments, implementation instructions 95 provides more than one API, each providing a different view of or with different aspects of functionality implemented by implementation instructions 95. For example, one API of implementation instructions 95 can provide a first set of functions and can be exposed to third party developers, and another API of implementation instructions 95 can be hidden (e.g., not exposed) and provide a subset of the first set of functions and also provide another set of functions, such as testing or debugging functions which are not in the first set of functions. In some embodiments, implementation instructions 95 calls one or more other components via an underlying API and thus be both a set of API calling instructions and a set of implementation instructions. It should be recognized that implementation instructions 95 can include additional functions, methods, classes, data structures, and/or other features that are not specified through API 90 and are not available to API calling instructions 80. It should also be recognized that API calling instructions 80 can be on the same system as implementation instructions 95 or can be located remotely and access implementation instructions 95 using API 90 over a network. In some embodiments, implementation instructions 95, API 90, and/or API-calling instructions 80 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

FIG. 1G illustrates a block diagram of different components of a system 100 that can be configured to implement the various techniques described herein, according to some embodiments. As shown in FIG. 1G, the system 100 can include a client computing device 102 and a server computing device 106. It is noted that, in the interest of simplifying this disclosure, the client computing device 102 and the server computing device 106 are discussed in singular capacities. In that regard, it should be appreciated that the system 100 can include any number of client computing devices 102 and server computing devices 106 without departing from the scope of this disclosure. According to some embodiments, the client computing device 102 and the server computing device 106 can represent any form of computing device operated by an individual, an entity, etc., such as a wearable computing device, a smartphone computing device, a tablet computing device, a laptop computing device, a desktop computing device, a rack mount computing device, a gaming computing device, a smart home computing device, an Internet of Things (IoT) computing device, and so on. It is noted that the foregoing examples are not meant to be limiting, and that the client computing device 102/server computing device 106 can represent any type, form, etc., of computing device, without departing from the scope of this disclosure.

As shown in FIG. 1G, and as described in greater detail herein, the client computing device 102 can issue search queries 104 to a server computing device 106 (e.g., via the Internet, a network connection, etc.), where, in turn, the server computing device 106 can generate and provide query results 128 to the client computing device 102 (over the aforementioned connections, a different connection, etc.). Additionally, the client computing device 102 can store conversation history information 103, which can include information associated with the search queries 104, the query results 128, as well as any other type, form, etc., of information, at any level of granularity, pertaining to the interactions between the client computing device 102 and the server computing device 106. According to some embodiments, the conversation history 103 can also represent/store other information associated with a user/the users of the client computing device 102, such as user account information, demographic-related information, device-related information (associated with the client computing device 102), and so on. It is noted that the conversation history 103 can be stored locally on the client computing device 102, the server computing devices 106, and/or any other computing devices, which can improve overall efficiency, enable synchronization functionalities, and so on. As described in greater detail herein, the conversation history 103 can be utilized to improve the overall accuracy of the query results 128 that are generated and provided by the server computing device 106.

As shown in FIG. 1G, the server computing device 106 can include a query planner 108. According to some embodiments, the query planner 108 can represent one or more artificial intelligence (AI) models-such as small language models (SLMs), large language models (LLMs), rule-based models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and so on. It is noted that the foregoing examples are not meant to be limiting, and that any number, type, form, etc., of AI model(s), can be implemented by any of the entities illustrated in FIG. 1G, without departing from the scope of this disclosure. According to some embodiments, the query planner 108 can be trained to receive search queries 104—typically in an “unstructured” or a “structured” form—and to output supplemental/corresponding queries in a structured form. According to some embodiments, the query planner 108 can be trained-commonly referred to as “fine-tuning”-to output the structured queries in accordance with particular styles, formats, domains, etc., so that the structured queries are well-suited for the other entities (discussed below) that receive and process the structured queries.

As a brief aside, and according to some embodiments, the query planner 108 can be configured to implement any number of AI models to determine whether a given search query 104 would benefit from being processed in accordance with the techniques described herein—as opposed to, for example, alternative techniques that may require fewer resources to carry out, yet provide satisfactory results. For example, the query planner 108 can generate, for a given search query 104, a score that represents a likelihood that utilizing the AI-based approaches described herein would be worthwhile. For example, the value of the score could scale with the complexity of the search query 104. In this manner, when the score satisfies a predetermined/tunable threshold, the query planner 108 can be configured to process the search query 104 in accordance with the techniques described herein. Conversely, when the score does not satisfy the predetermined/tunable threshold, the query planner 108 can be configured to process the search query 104 in accordance with the aforementioned alternative techniques.

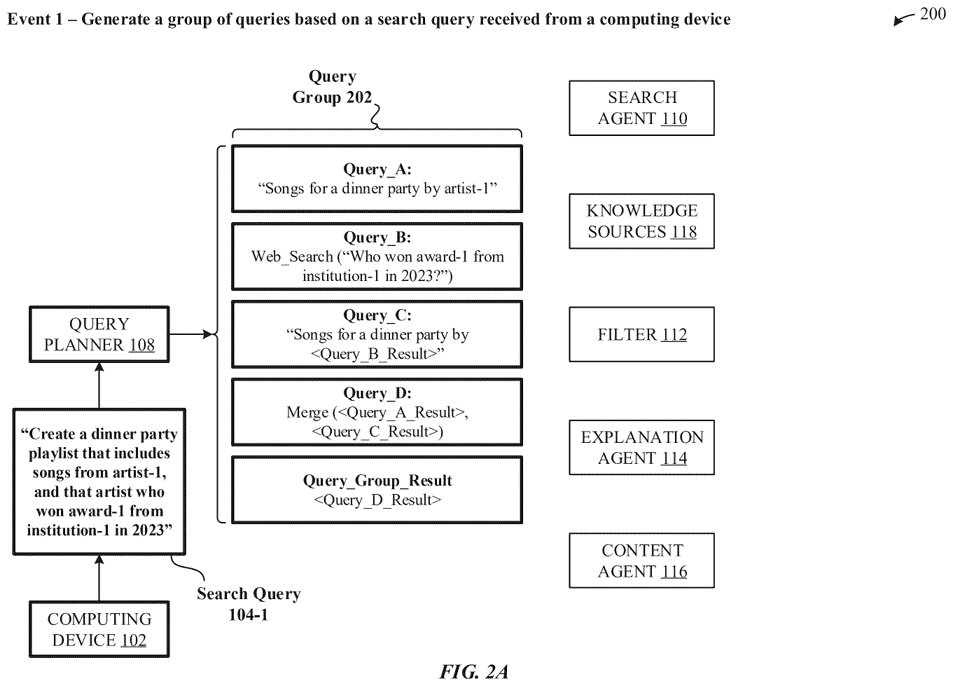

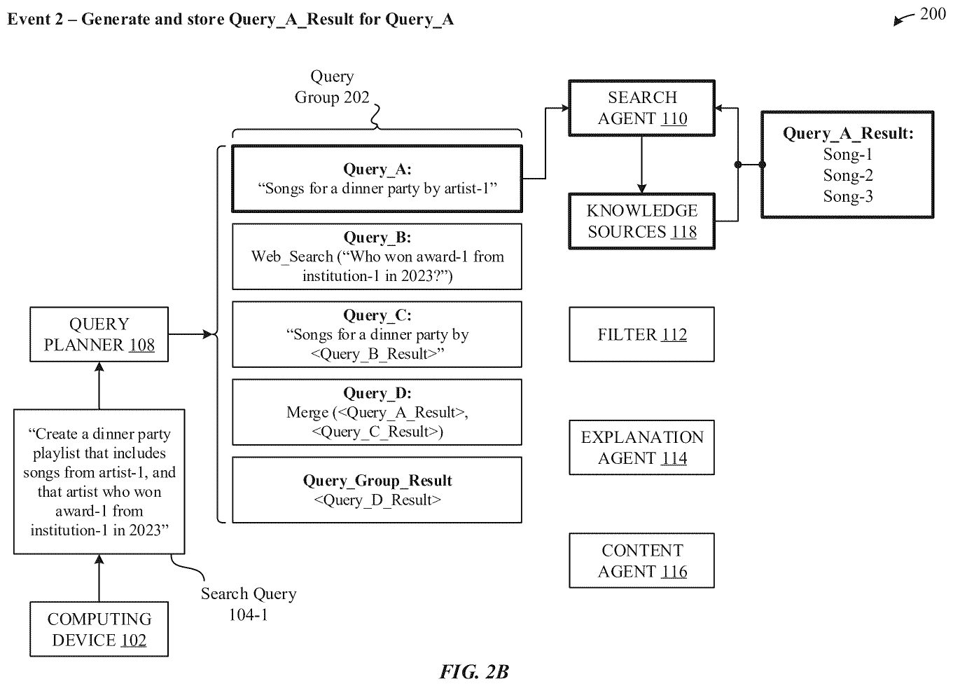

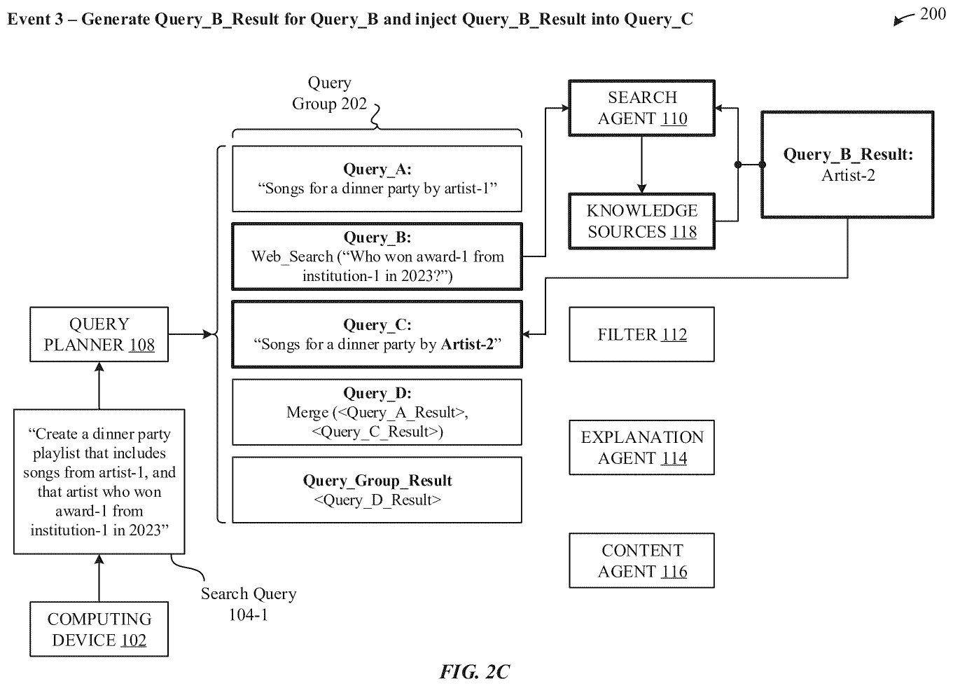

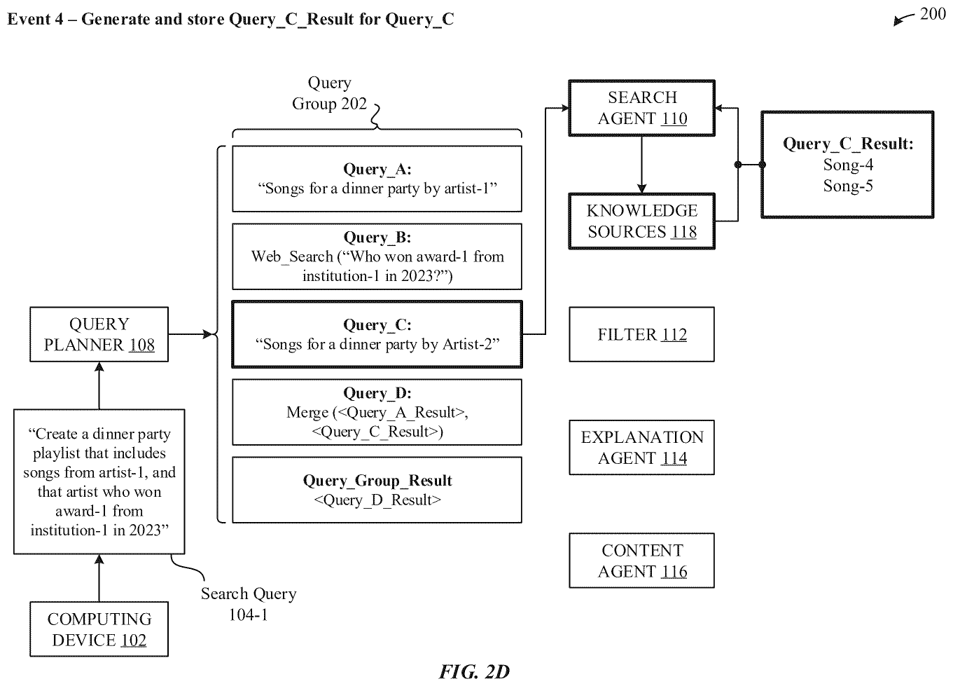

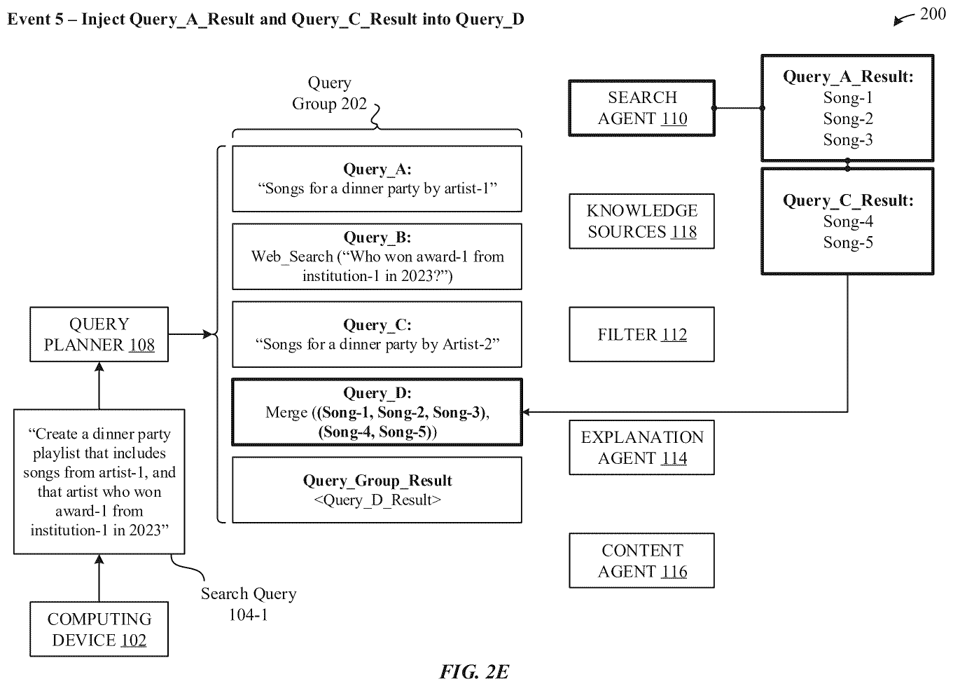

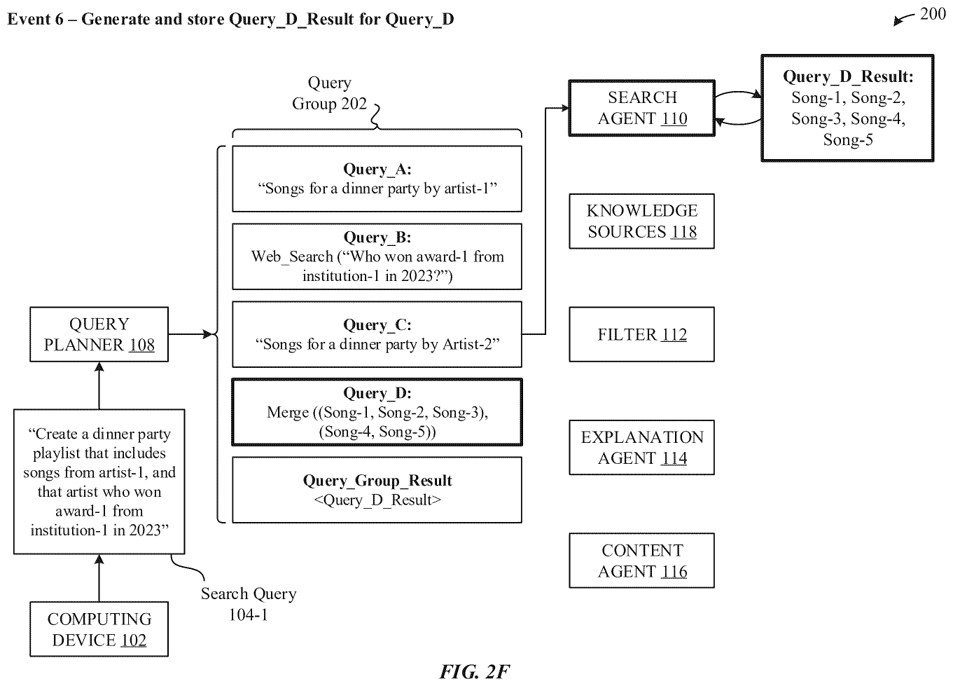

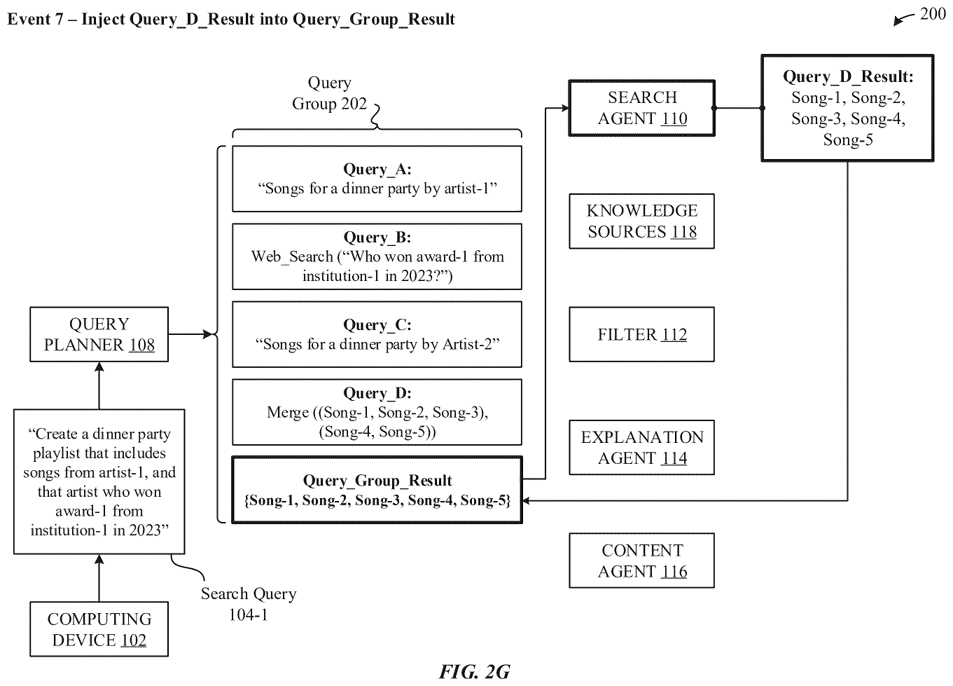

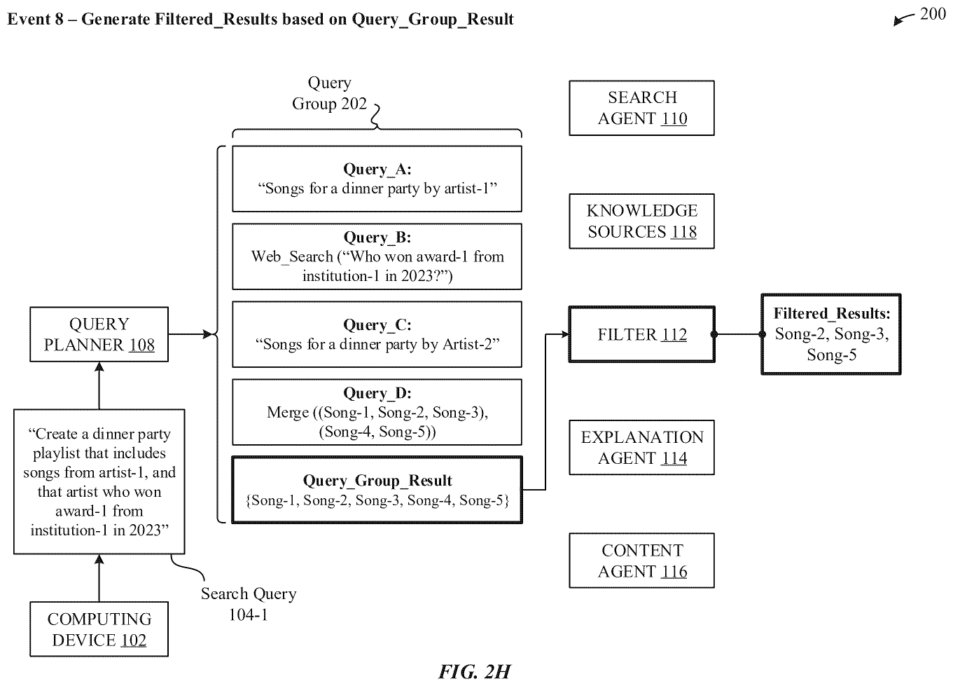

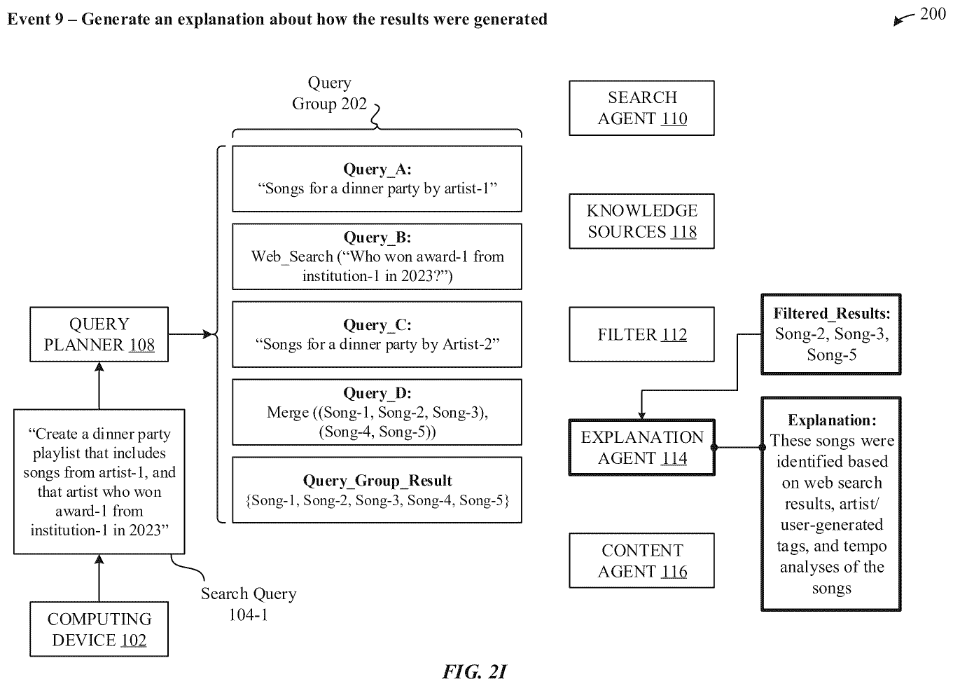

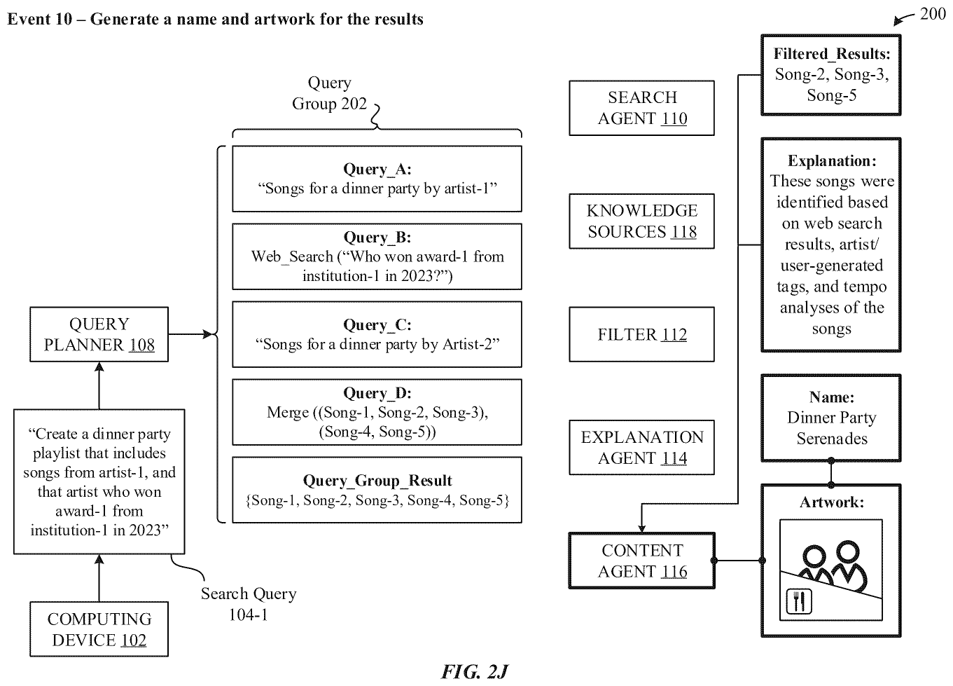

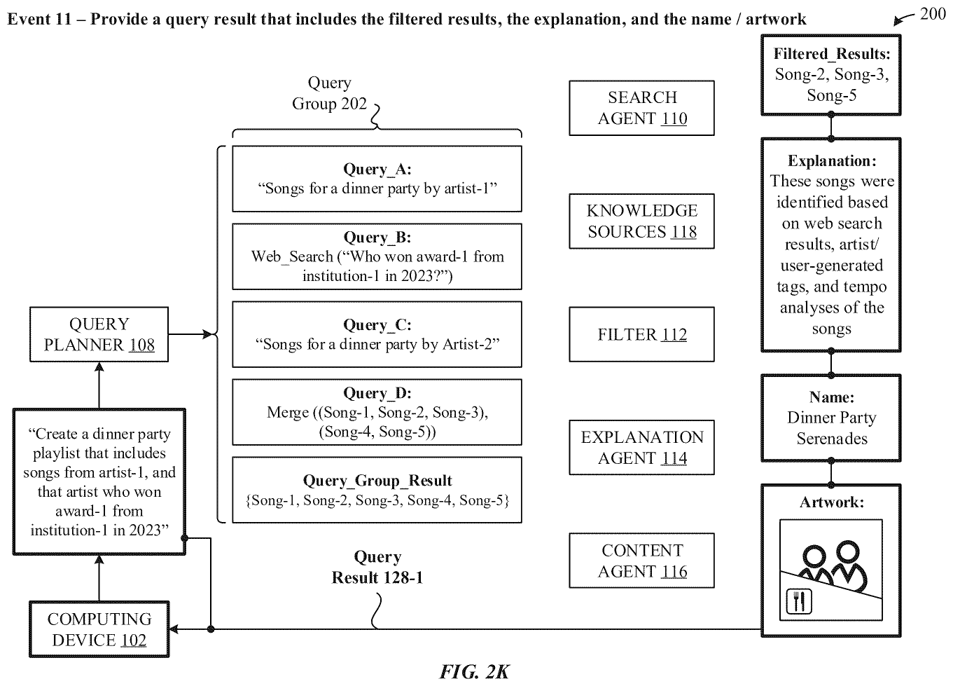

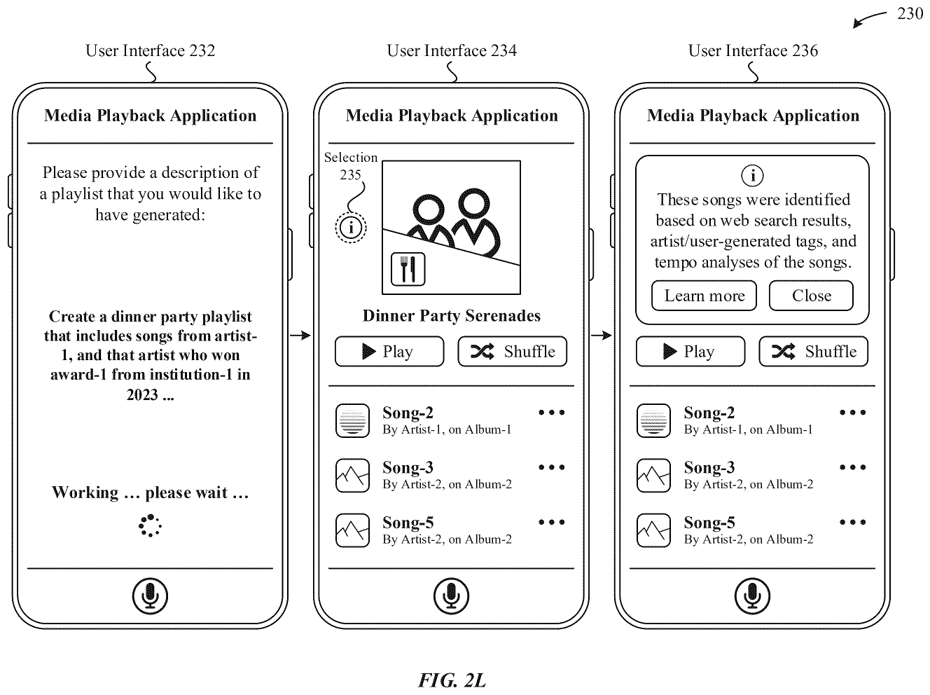

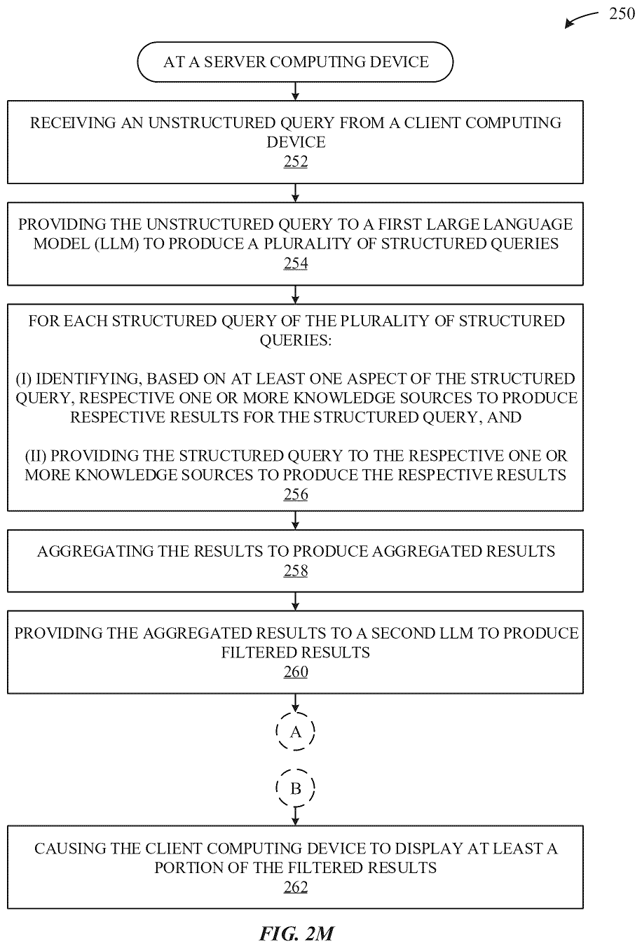

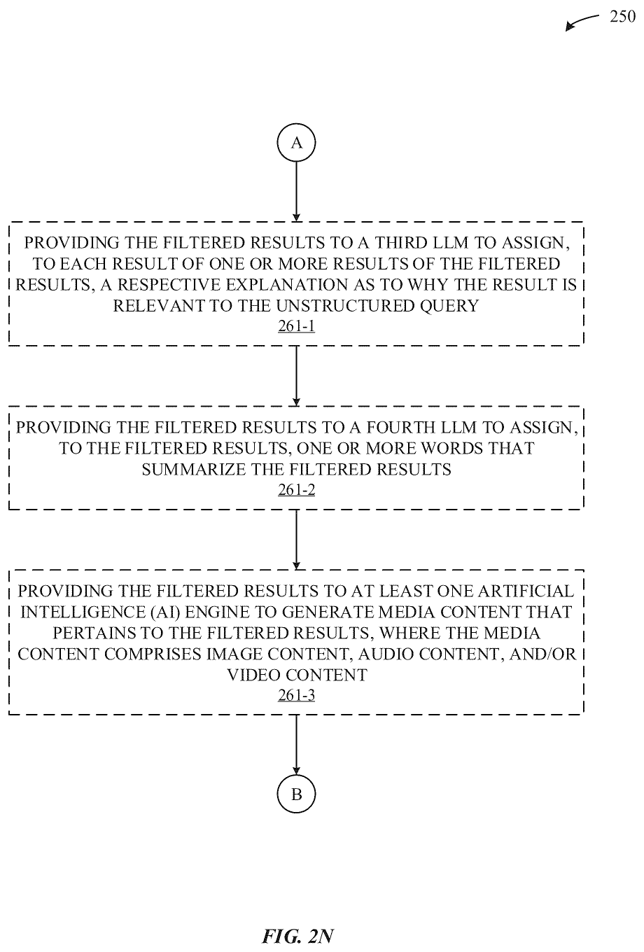

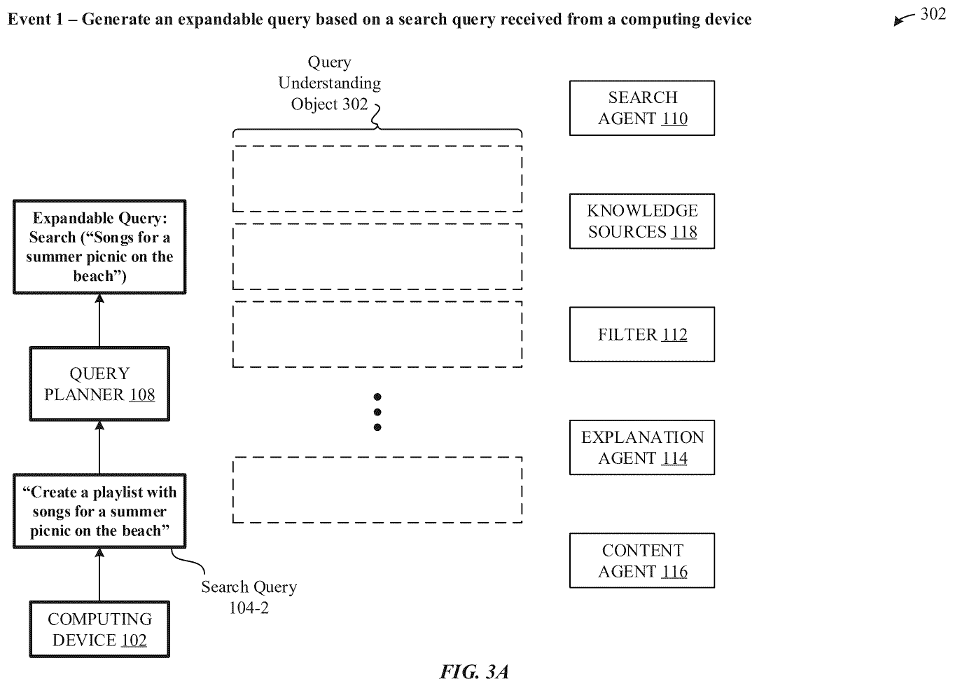

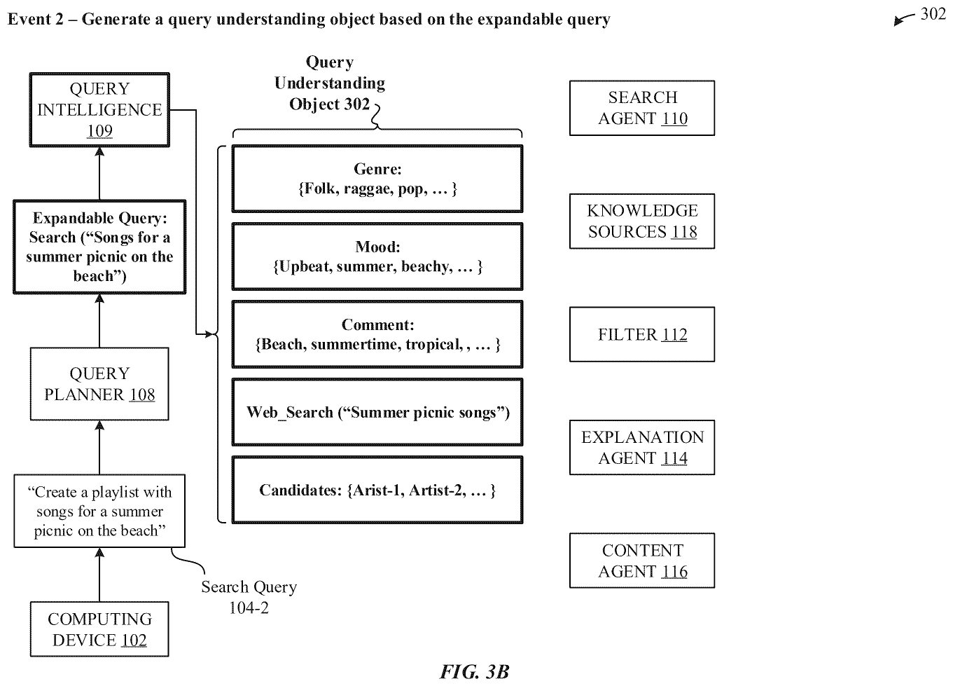

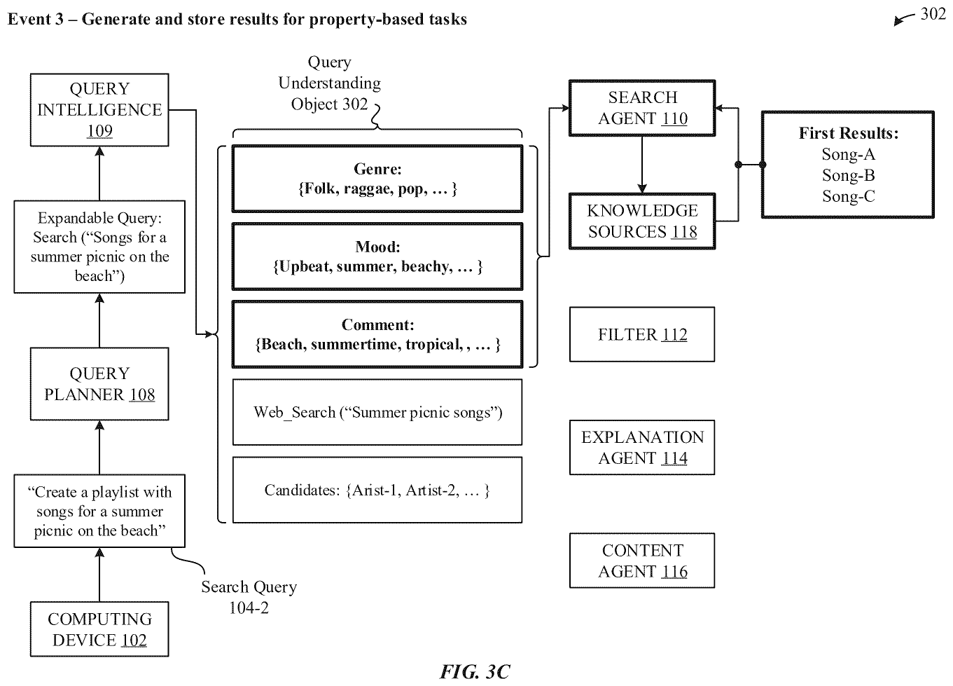

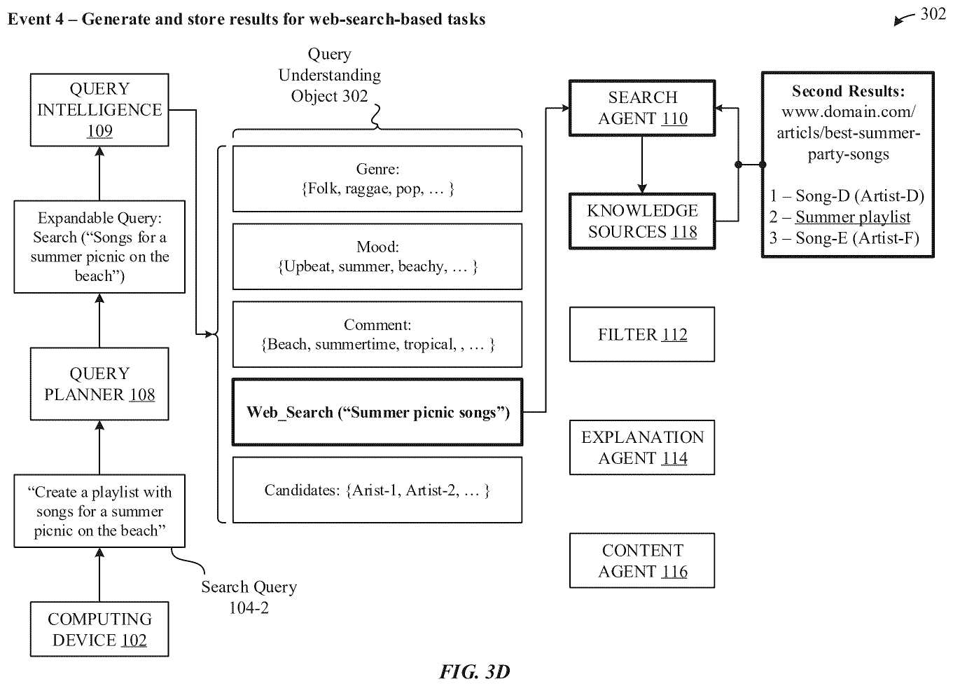

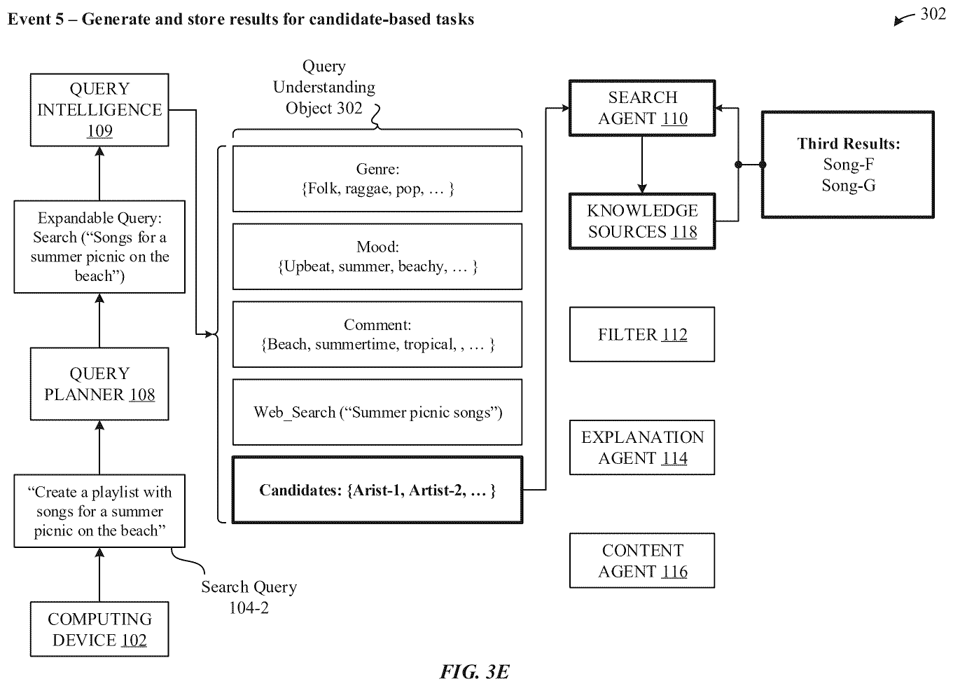

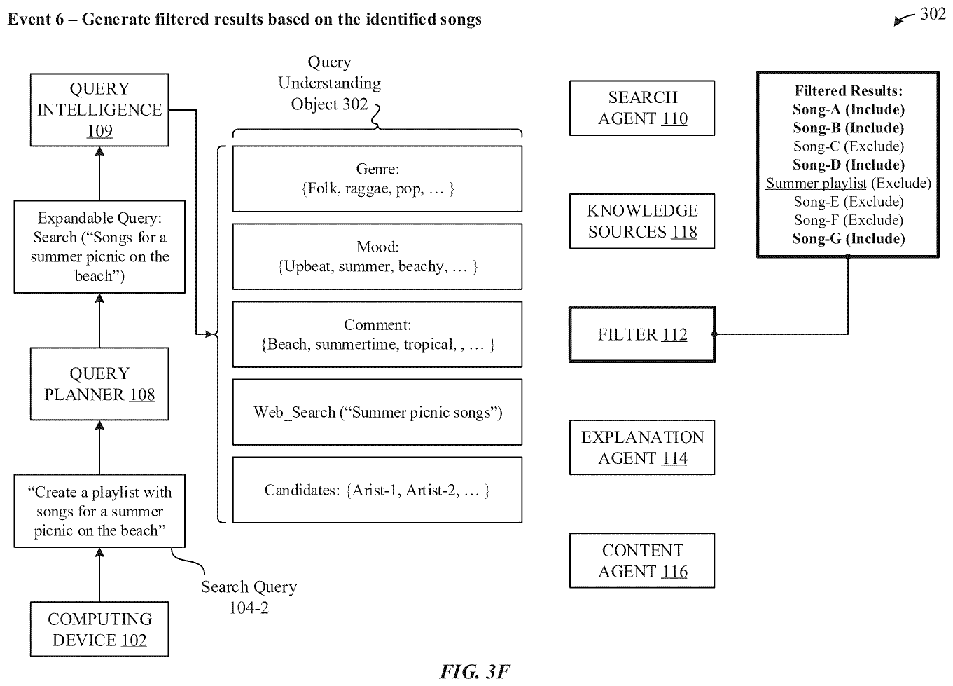

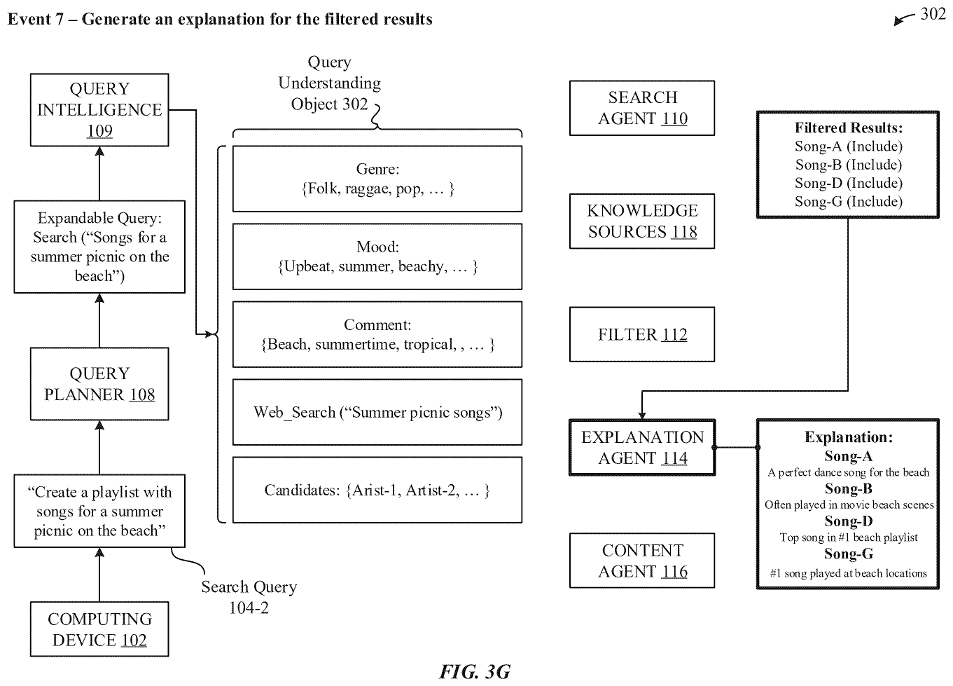

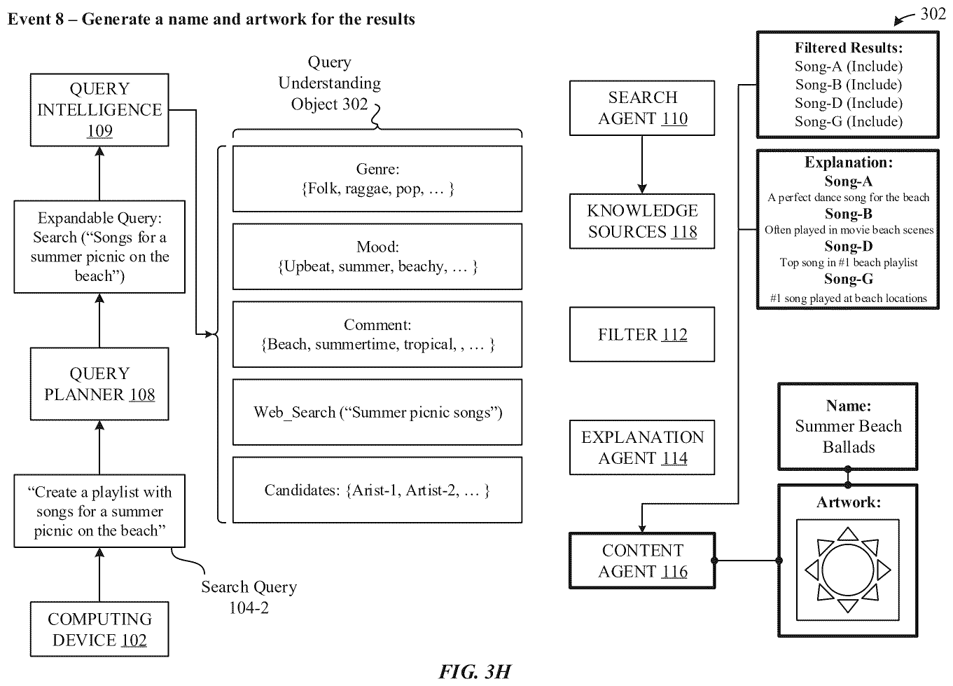

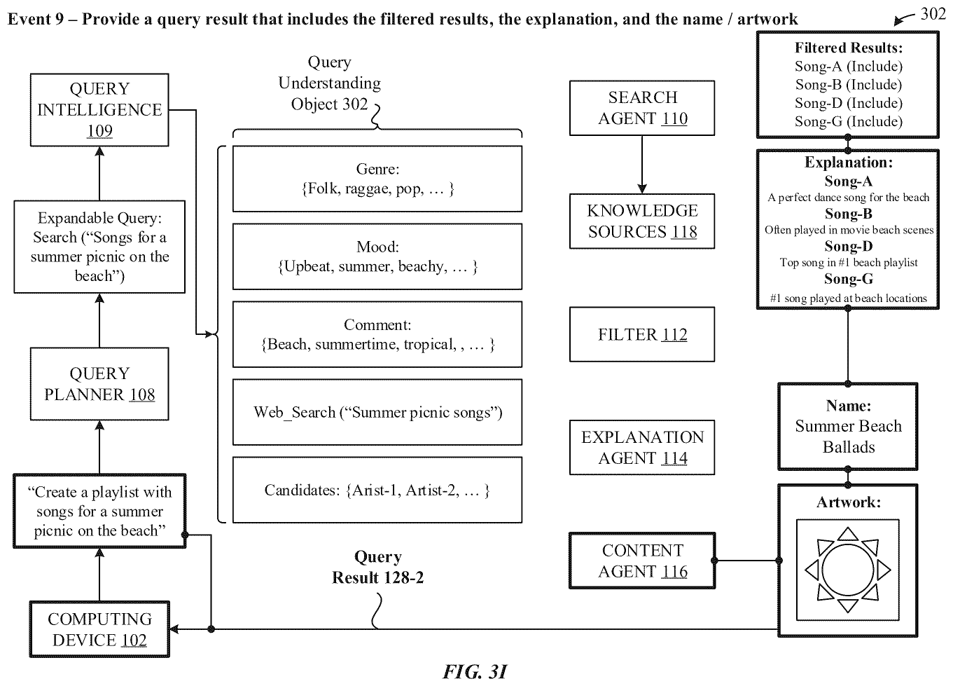

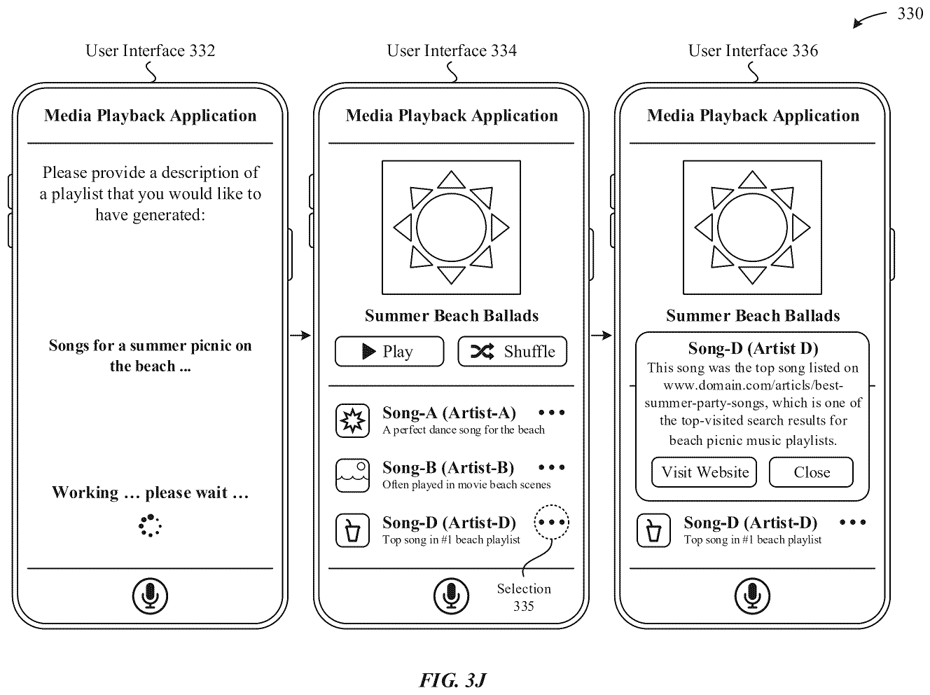

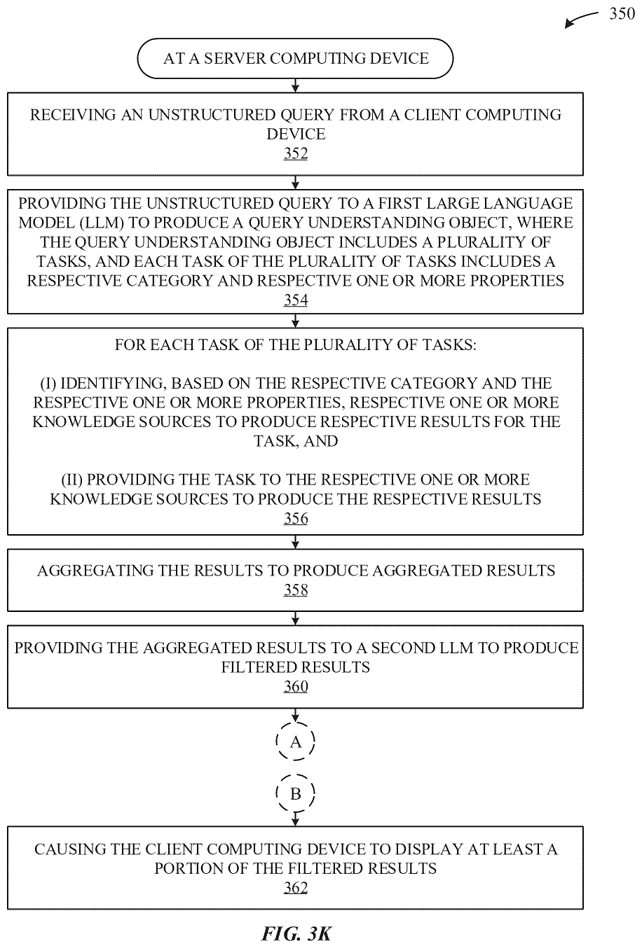

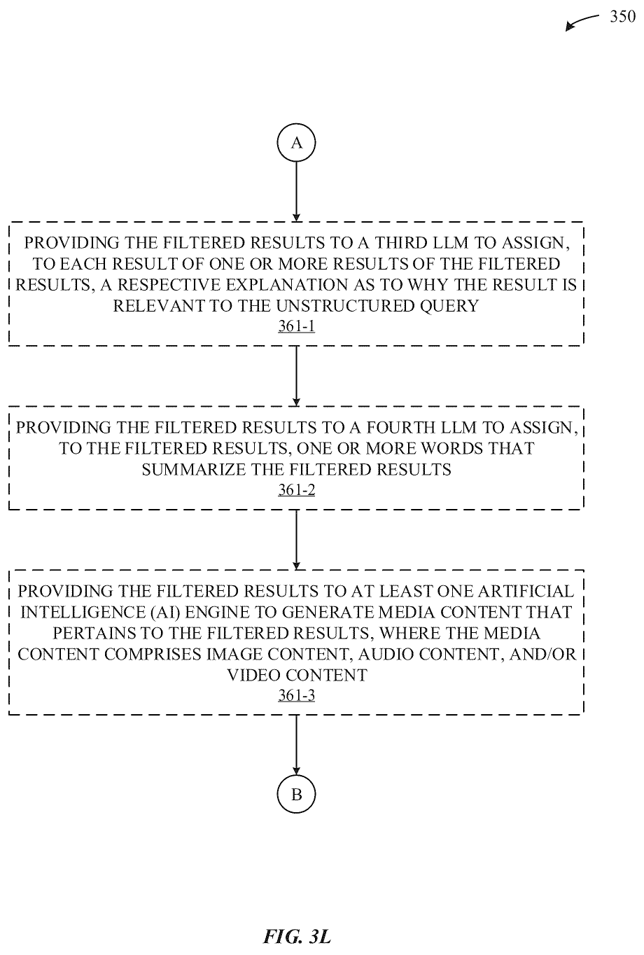

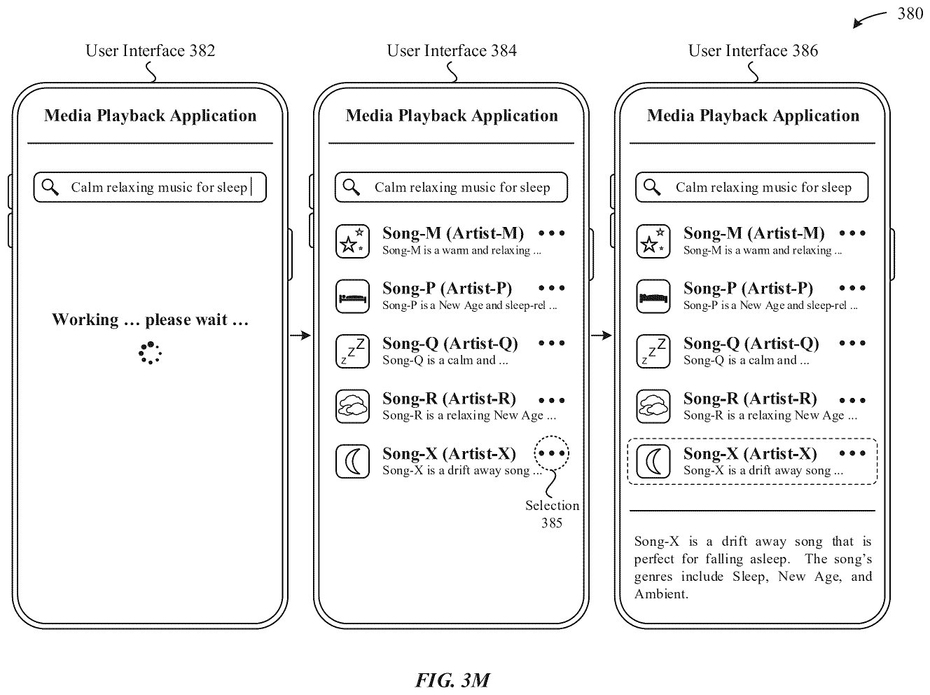

As described in greater detail herein, a given structured query (output by the query planner 108) can include all information that is needed for one or more additional entities-such as the knowledge sources 118—to execute the structured query. Alternatively, a given structured query can include one or more placeholders to be assigned values that are obtained from other structured queries. For example, when the query planner 108 receives a search query 104 with a request to “generate a playlist that includes 90s songs by artists who won awards from the most popular award ceremonies,” the query planner 108 can output (1) a structured query that searches the Internet (and/or other informational source(s)) to identify the most popular award ceremonies in the 90s, (2) a structured query that searches the Internet (and/or other informational source(s)) for artists who won the (identified) most popular award ceremonies in the 90s, and (3) a structured query that searches a music library (and/or other informational source(s)) for the (identified) artists. It is noted that the foregoing example is not meant to be limiting, and that a more detailed explanation of query expansion techniques implemented by the query planner 108 is provided below in conjunction with FIGS. 2A-2N and 3A-3M. It is also noted that a given query can include any number of placeholders, and that any level of nesting can be utilized to identify and assign values to the placeholders, without departing from the scope of this disclosure.

As shown in FIG. 1G, the structured queries output by the query planner 108 can be provided to a search agent 110. In turn, the search agent 110 can, for each structured query, interface with the appropriate knowledge sources 118 to obtain results for the structured query. According to some embodiments, the search agent 110 can employ any number/type of AI models to effectively identify, for a given structured query, the appropriate knowledge source(s) 118 to which the structured query should be directed. Alternatively (or additionally), the query planner 108 can assign, to one or more of the structured queries (that are output based on an unstructured query), the appropriate knowledge sources 118 to which the structured queries should be directed. In this manner, the search agent 110 can reduce or eliminate the aforementioned task of identifying knowledge sources 118 to which the structured queries should be directed, which can improve efficiency under certain configurations of the system 100.

According to some embodiments, and as shown in FIG. 1G, the knowledge sources 118 can include, for example, web search engines 120, question and answer (Q&A) knowledge sources 122, knowledge graphs 124, approximate nearest-neighbor (ANN) indexes 126, and so on. It is noted that the knowledge sources 118 illustrated in FIG. 1G and described herein are not meant to be limiting, and that the search agent 110 (as well as the other entities described herein) can be configured to access any type, kind, form, etc., of knowledge source 118 that is capable of receiving queries and providing responses, without departing from the scope of this disclosure. For example, the search agent 110 can access a mapping service that can return route times, road type information, landscape information, predicted weather information, etc., based on a given query. In this regard, when a search query 104 is relevant to the mapping service—e.g., a search query 104 that reads “generate a playlist for my drive from Irvine, CA to Yosemite National Park this weekend”—the query planner 108, query intelligence engine 109, search agent 110, etc., can interface with the mapping service to obtain (1) a predicted drive time from Irvine, CA to Yosemite National Park, (2) road/landscape information, including timestamp information where changes occur throughout the drive, (3) predicted weather information, and the like. In this manner, the playlist that is generated can have a length that corresponds to the drive time, as well as include song types that are suitable and ordered to coincide with the different types of roads, landscapes, etc., and weather that will be encountered along the way. Again, these examples are not meant to be limiting, and the query planner 108, query intelligence engine 109, search agent 110, etc., can employ any number, type, form, etc., of AI model(s), and interface with any type of informational service, to provide the various functionalities described herein, without departing from the scope of this disclosure.

According to some embodiments, the web search engines 120 can represent web search entities that are capable of receiving queries and providing answers based on what is accessible via the Internet. To implement this functionality, the web search engines 120 can “crawl” the Internet, which involves identifying, parsing, and indexing the content of web pages, such that relevant content can be efficiently identified in response to search queries that are received. In this manner, the web search engine 120 can be capable of providing information that is relevant to/useful for processing search queries 104 when they are received. For example, when a given web page is relevant to songs—e.g., a news article that discusses the top twenty songs for summertime—indexing the web page can include identifying each song referenced in the web page, matching each song to a song managed within a content database 111 (described below in greater detail), and linking the web page to the songs (e.g., by associating unique IDs of the songs to a uniform resource locator (URL) of the web page). Indexing the web page can also include, for one or more of the songs, extracting relevant text from the web page, generating new text based on the extracted text (and/or other information), etc., where the text provides an explanation of why the song is relevant to the web page. For example, the aforementioned example web page may state that a given song has “beach vibes that are perfect for summertime bonfires”. This statement can be extracted, modified, etc., to read “This song has beach vibes that are great for summertime beach bonfires.” The text can be associated with the URL/unique ID (of the song) so that they are associated with one another. In this regard, the web search engine 120 can effectively provide query results 128 that are relevant to search queries 104 and that include useful information (such as the web page URL, the relevant text obtained/generated from the web page, and so on). It is noted that the foregoing examples are not meant to be limiting, and that any amount, type, form, etc., of content can be extracted from a given web page, generated based on the web page, etc., at any level of granularity, consistent with the scope of this disclosure. As described herein, the web search engine 120 can also be configured to perform live searches, analyses, etc., of web pages to return relevant information about the web pages.

According to some embodiments, the Q&A knowledge sources 122 can represent systems, databases, etc., that can formulate answers to questions that are commonly received. To implement this functionality, the Q&A knowledge sources 122 typically rely on structured or semi-structured knowledge bases that contain a wide range of information, facts, data, or textual content that is manually curated, generated from text corpora, or collected from various sources, such as books, articles, databases, or the Internet.

According to some embodiments, the knowledge graphs 124 can represent systems, databases, etc., that can be accessed to formulate answers to queries that are received. A given knowledge graph 124 typically constitutes a structured representation of knowledge that captures relationships and connections between entities, concepts, data points, etc. in a way that computing devices are capable of understanding. According to some embodiments, the ANN indexes 126 can represent systems, databases, etc., that can be accessed to formulate answers to queries that are received. A given ANN index 126 typically constitutes a data structure that is arranged in a manner that enables similarity searches and retrievals in high-dimensional spaces to be efficiently performed. This makes the ANN indexes 126 particularly useful when performing tasks that involve information retrieval, recommendations, and finding similar data points, objects, and so on.

According to some embodiments, the search agent 110 can implement a query intelligence engine 109 that can receive one more structured queries (from the query planner 108) and generate additional search content for the structured queries. Consider an example scenario where the query planner 108 receives a search query 104 with a request to “generate a playlist that includes songs for a warm winter cabin in the snow.” Here, the query planner 108, when attempting to generate one or more structured queries (for the unstructured query), may only generate a single structured query—e.g., one that searches the Internet (and/or other informational source(s)) to identify “songs for a warm winter cabin in the snow”-which largely resembles the search query 104 that was originally received. Consequently, it can be beneficial for the structured query to be expanded prior to interfacing with the knowledge sources 118, as such an expansion likely will improve the overall accuracy, relevancy, etc., of the search results.

In this regard, and according to some embodiments, the search agent 110 can be configured to identify structured queries that have expansion potential, and pass such structured queries to the query intelligence engine 109 for expansion. Continuing with the example scenario discussed above, expanding the structed query “songs for a warm winter cabin in the snow” can involve, for example, separating the terms “warm winter cabin” and “snow” to be analyzed individually. In turn, the query intelligence engine 109 can expand (e.g., using one or more AI models) the term “warm winter cabin” into music-specific categories and corresponding properties, for example, “Genres: Folk/Acoustic, Jazz, Classical, Chillout/Ambient, Nature Sounds,” and “Moods: Warm, Cozy.” The query intelligence engine 109 can also expand (e.g., using one or more AI models) the term “snow” into, for example, “Genres: Classical, Holiday/Seasonal,” “Comments: Snow, Wintertime, Mountains, Log Cabin.” The query intelligence engine 109 can also generate (e.g., using one or more AI models) specific candidates based on the structured query, e.g., “Candidates: Artist-1, Arist-2, Artist-3,” where each of the aforementioned artists are known to match at least some of the terms in the structured query.

When the search agent 110/query intelligence engine 109 has expanded the structured query into additional search content, the search agent 110 can carry out the necessary tasks to provide results for the search query 104. Continuing with the example scenario discussed above, this would involve, for example, interfacing with the appropriate knowledge sources 118 to search the Internet to identify “songs for a warm winter cabin in the snow.” This would also involve interfacing with the appropriate knowledge sources 118 to identify songs that match “Genres: Folk/Acoustic, Jazz, Classical, Chillout/Ambient, Nature Sounds,” and “Moods: Warm, Cozy.” This would further involve interfacing with the appropriate knowledge sources 118 to identify songs that match “Genres: Classical, Holiday/Seasonal,” “Comments: Snow, Wintertime, Mountains, Log Cabin.” This would additionally involve interfacing with the appropriate knowledge sources 118 to identify songs that match “Candidates: Artist-1, Artist-2, Artist-3.” The results from these inquiries can then be aggregated and further-analyzed (in accordance with the techniques described below).

As a brief aside, it is noted that the foregoing examples are not meant to be limiting, and that unstructured/structured queries can be analyzed, parsed, segmented, etc., at any level of granularity, without departing from the scope of this disclosure. It is also noted that the search query expansion examples are not meant to be limiting, and that they can be expanded into any number, type, form, of additional search content(s), at any level of granularity, without departing from the scope of this disclosure. For example, the music-specific properties can include album information, artist information, beats per minute (BPM) information, composer information, conductor information, content group information, copyright information, cover art information, disk number information, encoding information, genre information, initial key information, mood information, original artist information, publisher information, release date information, subtitle information, track title information, track number information, and year information.

Turning back now to FIG. 1G, according to some embodiments, the server computing device 106 can be configured to implement a filter agent 112. According to some embodiments, the filter agent 112 can implement any number, type, form, etc., of AI model(s) to filter redundant, inaccurate, irrelevant, etc., results included in a given set of search results. The filter agent 112 can also be configured to identify and eliminate any search results that are considered to be “AI hallucinations,” which refer to the generation of false or distorted perceptions, ideas, or sensations by AI systems. This phenomenon can occur when AI models, such as LLMs, generate outputs that are not based on real data but instead originate from patterns or noise present in their training data or model architecture. Such hallucinations can manifest as incorrect information, fantastical scenarios, nonsensical sentences, or a blend of real and fabricated content.

To implement the foregoing functionalities, the filter agent 112 can analyze any information-such as the search query 104, the structured queries (e.g., provided by the query planner 108), the expanded structured queries (e.g., provided by the query intelligence engine 109), the search results, the conversation history 103 (associated with the client computing device 102 that issued the search query 104), and/or any other information-to remove redundant, inaccurate, irrelevant, hallucinatory, etc., results, if any, from the search results. According to some embodiments, to filter a given set of search results, the filter agent 112 can be configured to generate a respective relevance score for each result, sort the results by the relevance scores, and then keep/provide a threshold number of the best results (e.g., the top ten results) as the search results. According to some embodiments, a relevance score for a given result can be generated based on any amount, type, form, etc., of information, and any level of granularity, consistent with the scope of this disclosure. For example, when a result is obtained from a web page (e.g., using the web indexing techniques described herein), the filter agent 112 can be configured to analyze the web page from which the result was extracted, the extracted/modified text associated with the result, etc., against the search query 104 to determine whether the result is relevant to the search query 104, the other results, etc. The filter agent 112 can also look at information associated with the web page, such as historical performance metrics associated with the web page (e.g., page view count, unique visitor count, average session duration, bounce rate, returning visitors, engagement rate, etc.). It is noted that the foregoing examples are not meant to be limiting, and that the filter agent 112 can manage search results based on any amount, type, form, etc., of information, at any level of granularity, consistent with the scope of this disclosure.

According to some embodiments, the filter agent 112 can also be configured to interface with the content database 111—which, for example, stores music assets that can be played-back on client computing devices 102—to identify whether the music assets are available via the content database 111. This step can be beneficial in that songs that are identified—but are not accessible via the content database 111—are culled from the search results. A more detailed explanation of how the filter agent 112 implements the aforementioned techniques is provided below in conjunction with FIGS. 2A-N and 3A-3M.

Additionally, and according to some embodiments, the server computing device 106 can be configured to implement an explanation agent 114. According to some embodiments, the explanation agent 114 can be configured to implement any number, type, form, etc., of AI model(s) to receive the (filtered) search results from the filter agent 112, and provide explanations for one or more of the search results. To implement this functionality, the explanation agent 114 can analyze any information-such as the search query 104, the structured queries (e.g., provided by the query planner 108), the expanded structured queries (e.g., provided by the query intelligence engine 109), the search results, the conversation history 103 (associated with the client computing device 102 that issued the search query 104), and/or any other information. In one example, the explanation for a given search result can include a breakdown of why the search result is relevant, a breakdown of how the search result was identified, a breakdown of where the search result was located, and so on. It is noted that the foregoing examples are not meant to be limiting, and that the explanation can include any type, form, etc., of information, at any level of granularity, without departing from the scope of this disclosure.

Additionally, it is noted that, under some configurations, the explanation agent 114 can also be configured to provide explanations for search results that were filtered out by the filter agent 112. In turn, such explanations can be utilized in any manner to improve the manner in which the system 100 generates search results. For example, the explanations can be used to improve the intelligence of the various AI models discussed herein, to demonstrate to end-users that time is being saved by intelligently eliminating certain results for good/explainable reasons, and so on. A more detailed explanation of how the explanation agent 114 implements the aforementioned techniques is provided below in conjunction with FIGS. 2A-N and 3A-3M.

Additionally, and according to some embodiments, the server computing device 106 can be configured to implement a content agent 116. According to some embodiments, the content agent 116 can be configured to implement any number, type, form, etc., of AI model(s) to generate content that is relevant to the search results. For example, the content agent 116 can implement generative adversarial networks (GANs), variational autoencoders (VAEs), recurrent neural networks (RNNs), convolutional neural networks (CNNs), neuroevolution systems, deep dream systems, style transfer systems, rule-based systems, interactive evolutionary algorithms, and so on. Such content can include, for example, descriptive titles (e.g., playlist names) for groups of songs that are gathered, images (e.g., album art) that are representative of the groups of songs, and so on. It is noted that the foregoing examples are not meant to be limiting, and that the content agent 116 can generate any amount, type, form, etc., of digital content, at any level of granularity, without departing from the scope of this disclosure. For example, the content can include audio content, video content, document content, web content (e.g., hypertext markup language (HTML) content), programming language content, and so on.

According to some embodiments, when the server computing device 106 has employed one or more of the entities illustrated in FIG. 1G to generate search results, explanations, content, etc., for a given search query 104, the server computing device 106 can be configured to provide the aforementioned assets to the client computing device 102 (that issued the search query 104) in the form of query results 128. The query results 128 can be organized using any approach that is feasible for sending the aforementioned assets to the client computing device 102 in a manner that is understood by the client computing device 102. In turn the client computing device 102 can display the query results 128 using the appropriate applications, user interfaces, etc., to enable a user of the client computing device 102 to interact with the aforementioned assets. A more detailed explanation of how the client computing device 102 can enable its user to interact with the aforementioned assets is provided below in conjunction with FIGS. 2A-N and 3A-3M.

It is noted that the logical breakdown of the entities illustrated in FIG. 1G—as well as the logical flow of the manner in which such entities communicate-should not be construed as limiting. On the contrary, any of the entities illustrated in FIG. 1G can be separated into additional entities within the system 100, combined together within the system 100, or removed from the system 100, without departing from the scope of this disclosure. It is additionally noted that, in the interest of unifying and simplifying this disclosure, the described embodiments primarily pertain to accessing music content through search queries 104 and query results 128. However, it should be appreciated that the embodiments disclosed herein can be implemented to access any form of digital content, such as movies, television shows, books, documents, web pages, and so on. It is noted that the foregoing examples are not meant to be limiting, and that any amount, type, form, etc., of digital content can be accessed using the same or similar techniques to those described herein, without departing from the scope of this disclosure.

Additionally, it should be understood that the various components of the computing devices illustrated in FIG. 1G are presented at a high level in the interest of simplification. For example, although not illustrated in FIG. 1G, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

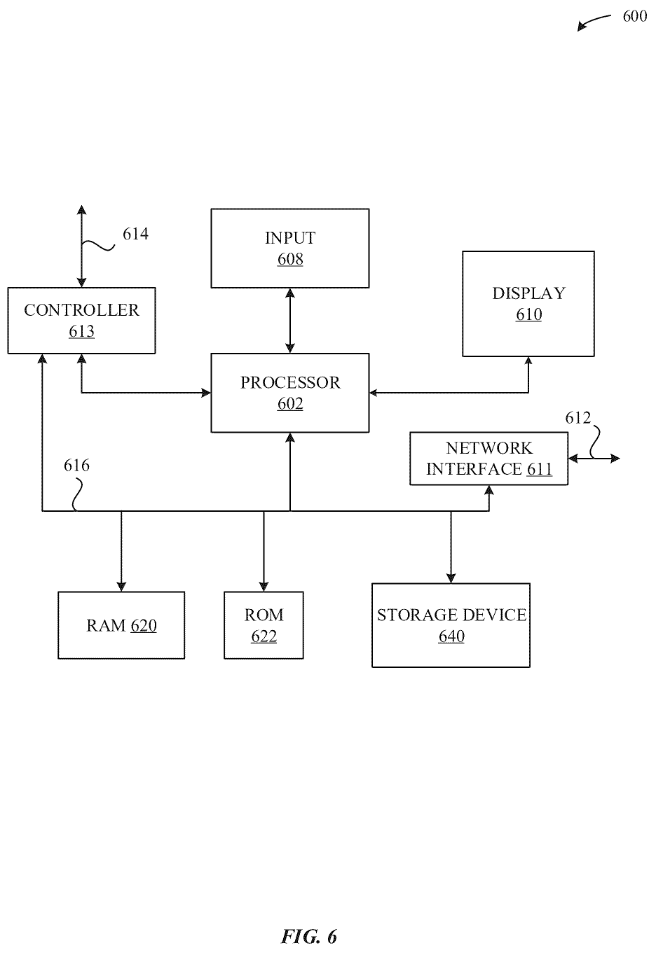

A more detailed explanation of these hardware components is provided below in conjunction with FIG. 6. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

Accordingly, FIG. 1G provides an overview of the manner in which the system 100 can implement the various techniques described herein, according to some embodiments. A more detailed breakdown of the manner in which these techniques can be implemented will now be provided below in conjunction with FIGS. 2A-N and 3A-3M.

FIGS. 2A-2K illustrate conceptual diagrams 200 of an example sequence of interactions between various entities described above in conjunction with FIG. 1G, according to some embodiments. As shown in FIG. 2A, a first event involves a client computing device 102 transmitting, to the server computing device 106, a search query 104-1 that includes the language “Create a dinner party playlist that includes songs from artist-1, and that artist who won award-1 from institution-1 in 2023.” In this regard, the search query 104-1 constitutes an unstructured query that can be analyzed, expanded, etc., in order to return high-quality search results, consistent with the techniques described herein. Accordingly, the query planner 108 (executing on the server computing device 106) can analyze the search query 104-1—e.g., using the AI-based techniques discussed above—and generate a query group 202 (of structured queries) based on the search query 104-1.

As a brief aside, it is noted that, in the interest of simplifying this disclosure, the described embodiments primarily involve the query planner 108 operating in an “earnest” capacity. For example, as described in conjunction with FIG. 2A, the query planner 108 generates, in a logically-singular capacity, various queries to include in the query group 202 (based on the search query 104-1). However, it should be appreciated that the query planner 108 can also be configured to operate in an “unearnest” capacity, consistent with the scope of this disclosure. Under this approach, the query planner 108 can be configured to individually/successively generate queries for the query group 202, where a given query in the query group 202 can rely on one or more previous queries (if any/where relevant) included in the query group 202.

As shown in FIG. 2A, the query group 202 includes five distinct structured queries (Query_A, Query_B, Query_C, Query_D, and Query_Group_Result). As shown in FIG. 2A, Query_A-which includes instructions to search for “Songs for a dinner party by artist-1”—constitutes a search query that does not rely on (i.e., does not include placeholders that correspond to) results produced by other search queries. In this regard, Query_A can be processed by the search agent 110, appropriate knowledge source(s) 118, etc., to obtain query results (Query_A_Result) for Query_A. Additionally, Query_B-which includes instructions to perform a web-based search for “Who won award-1 from institution 1 in 2023”—also constitutes a search query that does not rely on results produced by other search queries. In this regard, Query_B can be processed by the search agent 110, appropriate knowledge source(s) 118 (e.g., one or web search engines), etc., to obtain query results (Query_B_Result) for Query_B.

In contrast, and as shown in FIG. 2A, Query_C-which includes instructions to search for “Songs for a dinner party by <Query_B_Result>”-constitutes a search query that relies on the query results (Query_B_Result) associated with Query_B. In particular, for Query_C to be properly processed, Query_B_Result should be inserted into the placeholder value included in Query_C. In this regard, Query_B should be executed before Query_C so that Query_C ultimately includes the requisite information needed to appropriately process Query_C. In a similar vein, Query_D-which includes instructions to merge the query results Query_A_Result, Query_B_Result, and Query_C_Result-constitutes a query that relies on the query results produced by Query_A, Query_B, and Query_C, respectively. In this regard, Query_A, Query_B, and Query_C should be executed before Query_D so that Query_D ultimately includes the requisite information needed to appropriately process Query_D. Additionally, Query_Group_Result-which includes instructions to form a final result based on Query_D_Result-constitutes a query that relies on the query result produced by Query_D. In this regard, the completion of Query_D can ultimately enable the Query_Group_Result to be populated and finalized.

As a brief aside, it is noted that, in the interest of simplifying this disclosure, the described embodiments primarily involve nested queries having singular depth levels. For example, as shown in FIG. 2A, Query_C relies only on Query_B_Result, which constitutes a singular depth level. However, it should be appreciated that the query planner 108 can be configured to generate and process query groups 202 that include nested queries having any number of depth levels. For example, a modified version of the search query 104-1, a modified query group 202 generated by the query planner 108, etc., in FIG. 2A could involve Query_A relying on Query_B_Result (produced by Query_B), and could involve Query_B relying on Query_C result (produced by Query_C), such that Query_A effectively constitutes a query having two depth levels. It is noted that the foregoing example is not meant to be limiting, and that the query group 202 can include any number, type, form, etc., of query/queries, with any number of depth levels, consistent with the scope of this disclosure.

Additionally, and according to some embodiments, the query planner 108 can implement latency limitations to promote operating environments where query results 128 are able to be generated and returned in a reasonable amount of time. For example, when one or more queries included in a query group 202 have multiple depth levels, the query planner 108 can cause a warning to be displayed to the user (who submitted the search query 104), the query planner 108 can access additional computational resources to process the query group 202, and so on. It is noted that the foregoing examples are not meant to be limiting, and that the query planner 108 can utilize any number, type, form, etc., of approach(es), at any level of granularity, to effectively process search queries 104 in accordance with users' response-time expectations, consistent with the scope of this disclosure.

Accordingly, at the conclusion of FIG. 2A, the query group 202 constitutes a collection of structured queries that enable the search agent 110 to interface with knowledge sources 118 (and/or any other entities capable of handling the structured queries) to obtain query results. Accordingly, and as shown in FIG. 2B, a second event involves the search agent 110 processing Query_A to generate and store corresponding query results (Query_A_Result). As shown in FIG. 2B, the search agent 110 can interface with any number of knowledge sources 118 (and/or other entities) to formulate the query results, consistent with the techniques described herein. For example, the search agent 110 can provide Query_A to a web search engine, select the top three web pages returned by the web search engine (e.g., using one or more AI models), parse the web pages (e.g., using one or more AI models) to extract songs listed on the web pages, and then distill (e.g., using one or more AI models) the extracted songs into a finalized list.

As a brief aside, it is noted that the foregoing example search, analysis, distillation, etc., processes are not meant to be limiting. Additionally, it is noted that the search agent 110, the knowledge sources 118, etc., can take into account any additional information-such as the search query 104-1, the structured queries (e.g., any of those included in query group 202), expanded structured queries (e.g., any provided by the query intelligence engine 109, where appropriate, consistent with the techniques described herein), the conversation history 103 (associated with the client computing device 102 that issued the search query 104-1), and/or any other information—at any level of granularity, when processing the structured queries discussed herein. It is additionally noted that, in some cases, the search agent 110 can be capable of performing analyses independent from/complementary to the knowledge sources 118, without departing from the scope of this disclosure. For example, the search agent 110 can employ any number, type, kind, form, etc., of AI models, or other computational processes, to enable the search agent 110 to provide (or assist in providing) query results. In any case, at the conclusion of FIG. 2B, the search agent 110 stores the query results into Query_A_Result.

Turning now to FIG. 2C, a third event involves the search agent 110 processing Query_B to generate and store query results (Query_B_Result). As shown in FIG. 2C, the search agent 110 can interface with any number of knowledge sources 118 (and/or other entities) to formulate the query results (“Artist-2”), consistent with the techniques described herein. For example, a web engine can perform a web search for the query “Who won award-1 from institution-1 in 2023.” In turn, the web pages returned by the web engine can be parsed to identify an answer that appears to be the most correct (e.g., an answer provided on an official website associated with institution-1, an answer that is common among two or more web pages, etc.). The search agent 110 can then store the query results into Query_B_Result. Additionally, and as shown in FIG. 2C, the search agent 110 effectively injects Query_B_Result into the placeholder value in Query_C. In this regard, at the conclusion of the third event shown in FIG. 2C, Query_C possesses the information that is needed to effectively process Query_C.

Turning now to FIG. 2D, a fourth event involves the search agent 110 processing Query_C to generate and store query results (Query_C_Result). Again, and as shown in FIG. 2D, the search agent 110 can interface with any number of knowledge sources 118 (and/or other entities) to formulate the query results (Song-4 and Song-5) for Query_C, consistent with the techniques described herein. For example, the search agent 110 can interface with the content database 111, web search engines 120, Q&A knowledge sources, knowledge graphs, ANN indexes 126, and/or other entities, to identify songs associated with Artist-2, songs associated with artists like Artist-2, and so on. In turn, the search agent 110 can provide at least some of the identified songs to the knowledge sources 118 (and/or other entities) with instructions to identify a subset of songs that are appropriate for, relevant to, etc., a dinner party. Again, it is noted that the example processes described herein are not meant to be limiting.

In any case, the search agent 110 then stores the query results-Song-4 and Song-5 into Query_C_Result. Turning now to FIG. 2E, a fourth event involves the search agent 110 processing Query_D. As shown in FIG. 2E, processing Query_D involves merging the query results obtained for Query_A and Query_C (i.e., Query_A_Result (Song-1, Song-2, and Song-3), and Query_B_Result (Song-4 and Song 5), respectively) into a single set of results. Accordingly, the search agent 110 accesses the aforementioned query results. In turn, and as shown in FIG. 2F, a fourth event involves the search agent 110 generating and storing query results for Query_D (Song-1, Song-2, Song-3, Song-4, and Song-5). Additionally, and as shown in FIG. 2G, a seventh event involves the search agent 110 finalizing its processing of the query group 202 by effectively injecting Query_D_Result into Query_Group_Result. Accordingly, at the conclusion of FIG. 2G, all queries in the query group 202 have been processed, and the query results stored in Query_Group_Result can be further-processed by the server computing device 106.

Accordingly, and turning now to FIG. 2H, an eighth event involves the filter agent 112 processing the query results (stored in Query_Group_Result) to filter the results, e.g., using any of the filtration techniques described herein. As shown in FIG. 2H, the filtration can involve removing Song-1 and Song-4 from the query results, such that only Song-2, Song-3, and Song-5 remain. This filtration can take place, for example, when the search agent 110, knowledge sources 118, and/or other entities determine that Song-1 and Song-4 are irrelevant to, inappropriate for, etc., dinner parties. For example, Song-1 may have originally been identified because it corresponds to a popular and iconic dinner party scene in a children's cartoon movie. However, various elements can indicate that the playlist is intended for a grown-up dinner party, such as the instructions/desire to include songs from “that artist who won award-1 from institution-1 in 2023” in the search query 104-1 (where, for example, award-1 is typically awarded to mainstream artists), demographic information (e.g., stored in conversation history 103) indicating that the user of the client computing device 102 is an adult, calendar information (where access is permitted) indicating that a dinner party is approaching (as children do not typically maintain electronic calendars), and so on. When such indications are detected, Song-1 can be eliminated from the results, given, under at least most circumstances, it would be inappropriate for a song from a children's cartoon movie to begin playing during a dinner party for adults. It is noted that the foregoing examples are not meant to be limiting, and that any amount, type, form, etc., of information can be analyzed when determining whether each of the results should be filtered out or maintained.

Turning now to FIG. 2I, a ninth event involves the explanation agent 114 generating an explanation pertaining to the query results, e.g., using any of the explanation generation techniques described herein. As shown in FIG. 2I, the explanation constitutes a generalization of the manner in which the query results were obtained, filtered, and so on. The information included in the explanation can be gathered, formulated, etc., from, for example, the search agent 110, the knowledge sources 118, the filter agent 112, the conversation history 103, and/or other entities that were involved in delivering the results to the explanation agent 114. However, in some embodiments, and when/where appropriate, individual explanations can be provided for one or more of the query results.

Additionally, and turning to now to FIG. 2J, a tenth event involves the content agent 116 generating a name-“Dinner Party Serenades”—for the query results, e.g., using any of the content (e.g., name, title, etc.) generation techniques described herein. The content agent 116 can formulate the name based on, for example, the processes carried out by the search agent 110, the knowledge sources 118, the filter agent 112, and/or other entities, as well as the information that was processed and/or generated while carrying out such processes. The content agent 116 can also formulate the name based on the conversation history 103. It is noted that the foregoing examples are not meant to be limiting, and that any amount, type, form, etc., of information can be considered by the content agent 116 when generating the name, without departing from the scope of this disclosure.

Additionally, the tenth event also involves the content agent 116 generating artwork for the query results-which, as shown in FIG. 2J, depicts individuals at a dinner party, as well as dining utensils-using any of the content generation techniques described herein. The content agent 116 can formulate the artwork based on, for example, the processes carried out by the search agent 110, the knowledge sources 118, the filter agent 112, and/or other entities, as well as the information that was processed and/or generated while carrying out such processes. The content agent 116 can also formulate the artwork based on the conversation history 103. It is noted that the foregoing examples are not meant to be limiting, and that any amount, type, form, etc., of information can be considered by the content agent 116 when generating the artwork, without departing from the scope of this disclosure.

Accordingly, at the conclusion of FIG. 2J, the server computing device 106 is in possession of various content—e.g., the filtered results, the explanation, the name, the artwork, etc.—that can be provided to the client computing device 102 in response to the search query 104-1. Accordingly, and turning now to FIG. 2K, an eleventh event involves the server computing device 106 providing, to the computing device, a query result 128-1 that includes the aforementioned content. In turn, the client computing device 102 can process the content in a manner that is consistent with the search query 104-1. For example, because the search query 104-1/query result 128-1 pertain to music, the client computing device 102 can activate, launch, etc., a music playback application, a preview application, etc., capable of processing, displaying, etc., at least a portion of the content included in the query result 128-1. A more detailed explanation of how the client computing device 102 can generate the search query 104-1, as well as manage the query result 128-1 upon receipt, is provided below in conjunction with FIG. 2L.

FIG. 2L illustrates a conceptual diagram 230 of example user interfaces that can be provided by a client computing device 102 in conjunction with carrying out the steps described above conjunction with FIGS. 2A-2K, according to some embodiments. As shown in FIG. 2L, a user interface 232 can enable a user of the client computing device 102 to type, dictate, gesture, etc., information that is formed into the search query 104-1. Additionally, and as shown in FIG. 2L, a user interface 234 can display the name, the artwork, and the filtered results that are included in the query result 128-1 (returned in FIG. 2K). Supplemental information gathered from, for example, the content database 111 (and/or other entities) can also be displayed. For example, in the interest of decreasing the overall size of the query result 128-1, the filtered results may constitute unique identifiers (IDs) for Song-2, Song-3, and Song-5 (instead of, for example, audio files for the aforementioned songs). In this regard, receipt of such unique IDs can prompt the client computing device 102 to interface with content database 111 to extract additional content (e.g., artist information, album information, album artwork, etc.) associated with the aforementioned songs.

Additionally, and as shown in FIG. 2L, the user interface 234 can include a user interface object (also referred to herein as an “affordance”) that, when selected (via selection 235), causes the client computing device 102 to display additional information associated with the query result 128-1. As shown in the user interface 236, such additional information can include, for example, the explanation included in the query result 128-1. It is noted that the user interfaces illustrated in FIG. 2L are not meant to be limiting. On the contrary, any number, type, form, etc., of user interface(s), including any number, type, form, etc., of affordance(s), can be employed to effectively enable users of client computing devices 102 to generate search queries 104 and observe, interact with, etc., corresponding query results 128.

FIGS. 2M-2N illustrate a method 250 for generating query results 128 based on search queries 104, according to some embodiments. As shown in FIG. 2M, the method 250 begins at step 252, where the server computing device 106 receives an unstructured query from a client computing device (e.g., as described above in conjunction with FIGS. 1G and 2A-2L). At step 254, the server computing device 106 provides the unstructured query to a first large language model (LLM) to produce a plurality of structured queries (e.g., as also described above in conjunction with FIGS. 1G and 2A-2L).

At step 256, the server computing device 106 performs the following for each structured query of the plurality of structured queries: (i) identifying, based on at least one aspect of the structured query, respective one or more knowledge sources to produce respective results for the structured query, and (ii) providing the structured query to the respective one or more knowledge sources to produce the respective results (e.g., as also described above in conjunction with FIGS. 1G and 2A-2L). At step 258, the server computing device 106 aggregates the results to produce aggregated results (e.g., as also described above in conjunction with FIGS. 1G and 2A-2L). At step 260, the server computing device 106 provides the aggregated results to a second LLM to produce filtered results (e.g., as also described above in conjunction with FIGS. 1G and 2A-2L).

Turning now to FIG. 2N, at optional step 261-1, the server computing device 106 provides the filtered results to a third LLM to assign, to each result of one or more results of the filtered results, a respective explanation as to why the result is relevant to the unstructured query (e.g., as also described above in conjunction with FIGS. 1G and 2A-2L). At optional step 261-2, the server computing device 106 provides the filtered results to a fourth LLM to assign, to the filtered results, one or more words that summarize the filtered results (e.g., as also described above in conjunction with FIGS. 1G and 2A-2L). At optional step 261-3, the server computing device 106 provides the filtered results to at least one artificial intelligence (AI) engine to generate media content that pertains to the filtered results, where the media content comprises image content, audio content, and/or video content (e.g., as also described above in conjunction with FIGS. 1G and 2A-2L).

Turning back now to FIG. 2M, at step 262, the server computing device 106 causes the client computing device to display at least a portion of the filtered results.

FIGS. 3A-3I illustrate conceptual diagrams of another example sequence of interactions between various entities described above in conjunction with FIG. 1G, according to some embodiments. As shown in FIG. 3A, a first event involves a client computing device 102 transmitting, to the server computing device 106, a search query 104-2 that includes the language “Create a playlist with songs for a summer picnic on the beach.” In this regard, the search query 104-2 constitutes an unstructured query that can be analyzed, expanded, etc., in order to return high-quality search results, consistent with the techniques described herein. However, the search query 104-2 differs from the search query 104-1 (described above in conjunction with FIGS. 2A-2N), in that the search query 104-2 does not include specific references-such as “artist-1” and “artist who won award-1 from institution-1”—that otherwise enable the server computing device 106 to identify and deliver specific results. Instead, the search query 104-2 includes only vague/high-level terminology, such as “summer picnic on the beach.” In this regard, search query 104-2 constitutes a candidate to be processed by the query intelligence engine 109 so that specific references can be generated to enable specific results to be delivered.

Accordingly, the query planner 108 (executing on the server computing device 106) can analyze the search query 104-2—e.g., using the AI-based techniques discussed above—and generate, based on the search query 104-2, an expandable query (“Songs for a summer picnic on the beach”) for the query intelligence engine 109 to process. Turning now to FIG. 3B, a second event involves the query intelligence engine 109 generating a query understanding object 302 based on the expandable query. As shown in FIG. 3B, the query understanding object 302 includes five separate and distinct tasks to be processed, where each task includes a category and corresponding properties for the category. Accordingly, at the conclusion of FIG. 3B, the server computing device 106 is in possession of a query understanding object 302 that can be provided to the search agent 110, the knowledge sources 118, and/or other entities to obtain results that correspond to the tasks included in the query understanding object 302.

Turning now to FIG. 3C, a third event involves the search agent 110 identifying, among the tasks associated with the query understanding object 302, tasks that are similar to one another and that can be grouped for execution. It is noted, however, that task grouping can be performed using alternative approaches, or omitted (where, instead, tasks are individually processed), without departing from the scope of this disclosure. As shown in FIG. 3C, the first three tasks (from top to bottom) are similar to one another in that their corresponding categories specifically relate to aspects of metadata that are typically associated with music files. In this regard, the search agent 110, knowledge sources 118, content database 111, and/or other entities can operate (e.g., using one or more AI models, consistent with the techniques described herein) on the first three tasks to identify songs that match the categories/properties specified within the first three tasks. As shown in FIG. 3C, operating on the first three tasks produces first results that include Song-A, Song-B, and Song-C.

Turning now to FIG. 3D, a fourth event involves the search agent 110 identifying a next task included in the query understanding object 302. As shown in FIG. 3D, the next task constitutes a task to search the Internet for “Summer picnic songs.” In turn, the search agent 110 interfaces with the appropriate entity/entities-such as one or more web search engines 120—to obtain search results for the aforementioned search terms, and to store the search results as second results. As shown in FIG. 3D, the second results include the uniform resource locator (URL) of a web page that was identified as a top choice (e.g., by the web search engines 120, by one or more AI models analyzing the results provide by the web search engines 120, etc.) for possessing information related to summer picnic songs. As also shown in FIG. 3D, the second results include information parsed, extracted, etc., from the web page (e.g., using one or more AI-based approaches, using an HTML analysis tool, etc.), including Song-D (by Artist-D), a hyperlink to a “Summer playlist”, and Song-E (by Artist-F).

Turning now to FIG. 3E, a fifth event involves the search agent 110 identifying a next (and final) task included in the query understanding object 302. As shown in FIG. 3E, the final task constitutes a task to perform direct searches for the specific artists Artist-1, Artist-2, and other artists. In this regard, the search agent 110, knowledge sources 118, content database 111, and/or other entities can operate (e.g., using one or more AI models, consistent with the techniques described herein) on the final task to identify songs that match the artists specified in the final task. As shown in FIG. 3E, operating on the final task produces third results that include Song-F and Song-G. Accordingly, at the conclusion of FIG. 3E, all tasks in the query understanding object 302 have been processed, and the first, second, and third results can be further-processed by the server computing device 106.

Accordingly, and turning now to FIG. 3F, a sixth event involves the filter agent 112 processing the first, second, and third results, e.g., using any of the filtration techniques described herein. As shown in FIG. 3F, the filtration can involve removing Song-C, the summer playlist hyperlink, Song-E, and Song-F, such that only Song-A, Song-B, Song-D, and Song-G remain intact. The exclusion of the summer playlist hyperlink can take place, for example, when the search agent 110, knowledge sources 118, and/or other entities determine that the summer playlist hyperlink does not, in and of itself, constitute a song, but instead constitutes a hyperlink (e.g., to another web page that includes another listing of songs). Additionally, Song-C, Song-E, and Song-F can be excluded for other reasons that are consistent with the scope of this disclosure, e.g., when such songs are irrelevant to, inappropriate for, etc., summer picnics on the beach.

Turning now to FIG. 3G, a seventh event involves the explanation agent 114 generating individual explanations pertaining to the filtered results, e.g., using any of the explanation generation techniques described herein. As shown in FIG. 3G, each explanation constitutes a specific breakdown of why the corresponding song was selected for—and survived the filter for—the desired playlist. The information included in the explanations can be gathered, formulated, etc., from, for example, the search agent 110, the knowledge sources 118, the filter agent 112, the conversation history 103, and/or other entities that were involved in delivering the results to the explanation agent 114.

Additionally, and turning to now to FIG. 3H, an eighth event involves the content agent 116 generating a name-“Summer Beach Ballads”—for the query results, e.g., using any of the content (e.g., name, title, etc.) generation techniques described herein. The content agent 116 can formulate the name based on, for example, the processes carried out by the search agent 110, the knowledge sources 118, the filter agent 112, and/or other entities, as well as the information that was processed and/or generated while carrying out such processes. The content agent 116 can also formulate the name based on the conversation history 103. Again, it is noted that the foregoing examples are not meant to be limiting, and that any amount, type, form, etc., of information can be considered by the content agent 116 when generating the name, without departing from the scope of this disclosure.

Additionally, the eighth event also involves the content agent 116 generating artwork for the query results-which, as shown in FIG. 3H, depicts a sun symbol-using any of the content generation techniques described herein. The content agent 116 can formulate the artwork based on, for example, the processes carried out by the search agent 110, the knowledge sources 118, the filter agent 112, and/or other entities, as well as the information that was processed and/or generated while carrying out such processes. The content agent 116 can also formulate the artwork based on the conversation history 103. It is noted that the foregoing examples are not meant to be limiting, and that any amount, type, form, etc., of information can be considered by the content agent 116 when generating the artwork, without departing from the scope of this disclosure.

Accordingly, at the conclusion of FIG. 3H, the server computing device 106 is in possession of various content—e.g., the filtered results, the explanation, the name, the artwork, etc.—that can be provided to the client computing device 102 in response to the search query 104-2. Accordingly, and turning now to FIG. 3I, a ninth event involves the server computing device 106 providing, to the computing device, a query result 128-2 that includes the aforementioned content. In turn, and as described herein, the client computing device 102 can process the content in a manner that is consistent with the search query 104-2.

FIG. 3J illustrates a conceptual diagram 330 of example user interfaces that can be provided by a client computing device 102 in conjunction with carrying out the steps described above in conjunction with FIGS. 3A-3I, according to some embodiments. As shown in FIG. 3J, a user interface 332 can enable a user of the client computing device 102 to type, dictate, gesture, etc., information that is formed into the search query 104-2. Additionally, and as shown in FIG. 3J, a user interface 334 can display the name, the artwork, and the filtered results that are included in the query result 128-2 (returned in FIG. 3I). The user interface 336 can also display the respective explanations for the filtered results. Additionally, and as shown in FIG. 3J, the user interface 334 can include, for each of the filtered results, a respective user interface object (also referred to herein as an “affordance”). In particular, when one of the user interface objects is selected-such as the user interface object for Song-D (via selection 335)—the selection causes the client computing device 102 to display expanded information about the song itself, the reason why the song was selected, the location from which the song was gathered (as well as an option to access the location), and so on. It is noted that the foregoing examples are not meant to be limiting, and that the expanded information can include any amount, type, form, etc., of information, at any level of granularity, without departing from the scope of this disclosure. It is additionally noted that the user interfaces illustrated in FIG. 3J are not meant to be limiting. On the contrary, any number, type, form, etc., of user interface(s), including any number, type, form, etc., of affordance(s), can be employed to effectively enable users of client computing devices 102 to generate search queries 104 and observe, interact with, etc., corresponding query results 128.

FIGS. 3K-3L illustrate a method 350 for generating query results 128 based on search queries 104, according to some embodiments. As shown in FIG. 3K, the method 350 begins at step 352, where the server computing device 106 receives an unstructured query from a client computing device (e.g., as also described above in conjunction with FIGS. 1G, 2A-2N, and 3A-3J). At step 354, the server computing device 106 provides the unstructured query to a first large language model (LLM) to produce a query understanding object, where the query understanding object includes a plurality of tasks, and each task of the plurality of tasks includes a respective category and respective one or more properties (e.g., as also described above in conjunction with FIGS. 1G and 3A-3J).

At step 356, the server computing device 106 performs the following for each task of the plurality of tasks: (i) identifying, based on the respective category and the respective one or more properties, respective one or more knowledge sources to produce respective results for the task, and (ii) providing the task to the respective one or more knowledge sources to produce the respective results (e.g., as also described above in conjunction with FIGS. 1G and 3A-3J). At step 358, the server computing device 106 aggregates the results to produce aggregated results (e.g., as also described above in conjunction with FIGS. 1G, 2A-2N, and 3A-3J). At step 360, the server computing device 106 provides the aggregated results to a second LLM to produce filtered results (e.g., as also described above in conjunction with FIGS. 1G, 2A-2N, and 3A-3J).

Turning now to FIG. 3L, at optional step 361-1, the server computing device 106 provides the filtered results to a third LLM to assign, to each result of one or more results of the filtered results, a respective explanation as to why the result is relevant to the unstructured query (e.g., as also described above in conjunction with FIGS. 1G, 2A-2N, and 3A-3J). At optional step 361-2, the server computing device 106 provides the filtered results to a fourth LLM to assign, to the filtered results, one or more words that summarize the filtered results (e.g., as also described above in conjunction with FIGS. 1G, 2A-2N, and 3A-3J). At optional step 361-3, the server computing device 106 provides the filtered results to at least one artificial intelligence (AI) engine to generate media content that pertains to the filtered results, where the media content comprises image content, audio content, and/or video content (e.g., as also described above in conjunction with FIGS. 1G, 2A-2N, and 3A-3J).

Turning back now to FIG. 3K, at step 362, the server computing device 106 causes the client computing device to display at least a portion of the filtered results (e.g., as also described above in conjunction with FIGS. 1G, 2A-2N, and 3A-3J).

Additionally, FIG. 3M illustrates a conceptual diagram 380 of additional example user interfaces that can be provided by a client computing device 102 in conjunction with carrying out the steps described above in conjunction with FIGS. 3K-3L, according to some embodiments. As shown in FIG. 3M, a user interface 382 can enable a user of the client computing device 102 to type, dictate, gesture, etc., information that is formed into a search query 104. Additionally, and as shown in FIG. 3M, a user interface 384 can display names, artwork, and filtered results that are included in query results 128 for the aforementioned search query 104. The user interface 386 can also display respective explanations for each of the filtered results. Additionally, and as shown in FIG. 3M, the user interface 384 can include, for each of the filtered results, a respective user interface object (also referred to herein as an “affordance”). In particular, when one of the user interface objects is selected-such as the user interface object for Song-X (via selection 385)—the selection causes the client computing device 102 to display expanded information about the song, such as information about the song itself, information about why the song was selected for the playlist, reasons that the song is relevant to the playlist, and so on. It is noted that the foregoing examples are not meant to be limiting, and that the expanded information can include any amount, type, form, etc., of information, at any level of granularity, without departing from the scope of this disclosure. Again, it is noted that the user interfaces illustrated in FIG. 3M are not meant to be limiting. On the contrary, any number, type, form, etc., of user interface(s), including any number, type, form, etc., of affordance(s), can be employed to effectively enable users of client computing devices 102 to generate search queries 104 and observe, interact with, etc., corresponding query results 128.

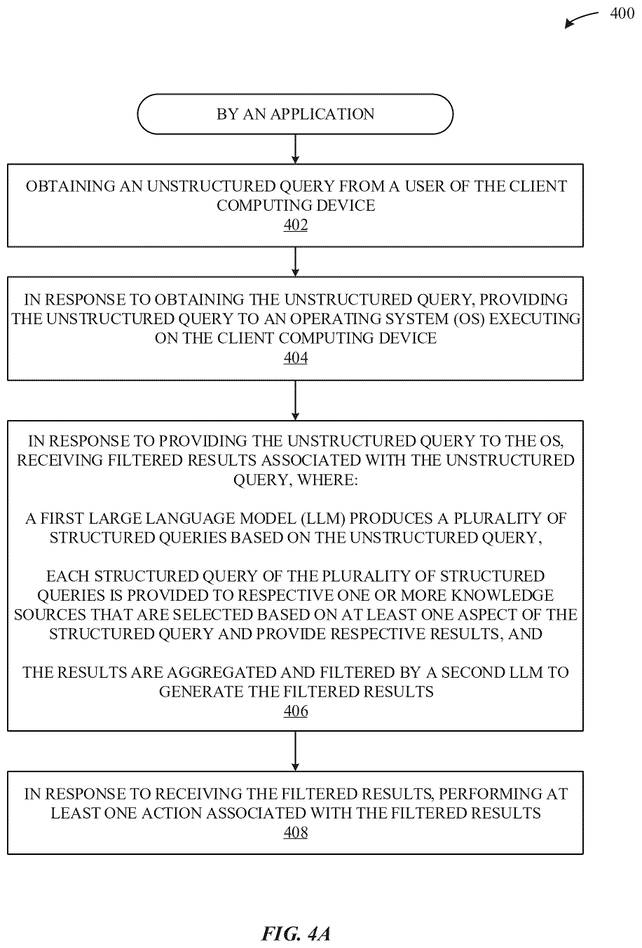

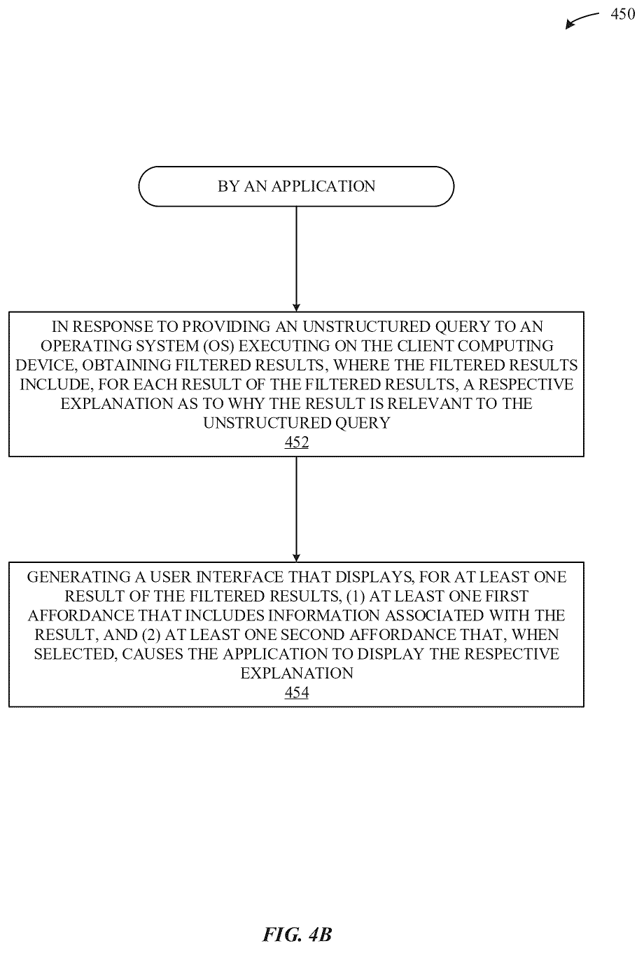

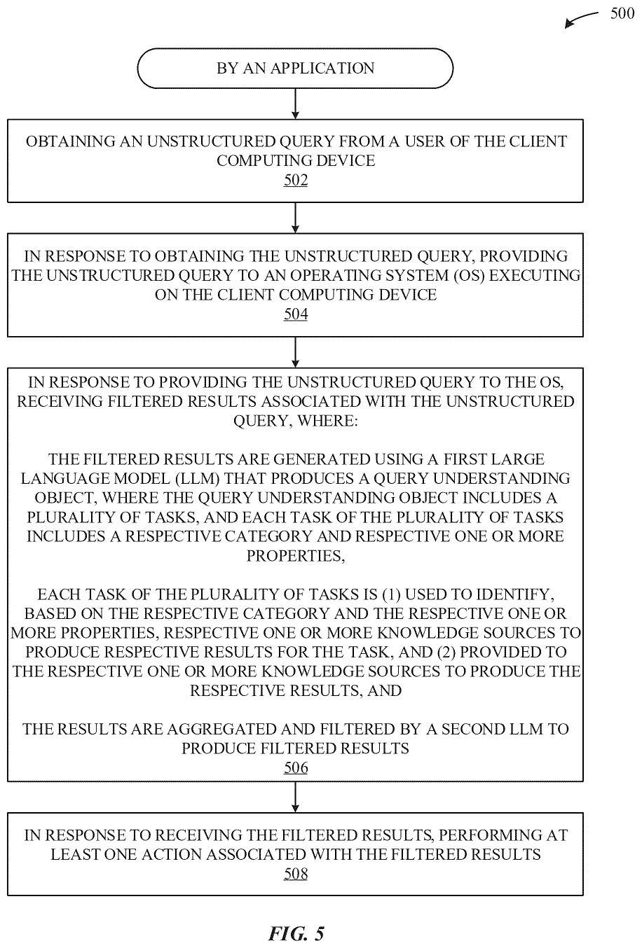

In some embodiments, methods 400, 450, and 500 (illustrated in FIGS. 4A, 4B, 5) are performed at a first computer system (as described herein) via a system process (e.g., an operating system process, a server system process, etc.) that is different from one or more applications executing and/or installed on the first computer system. In some embodiments, the methods 400, 450, and 500 are performed at a first computer system (as described herein) by an application that is different from a system process. In some embodiments, the instructions of the application, when executed, control the first computer system to perform the methods 400, 450, and 500 by calling an application programming interface (API) provided by the system process. In some embodiments, the application performs at least a portion of the methods 400, 450, and 500 without calling the API.

In some embodiments, the application can be any suitable type of application, including, for example, one or more of: a search application, a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first party application). In other embodiments, the application is an application that is provided to the first computer system via an operating system update file (e.g., a first party application). In other embodiments, the application is an application that is provided via an application store. In some implementations, the application store is pre-installed on the first computer system at purchase (e.g., a first party application store) and allows download of one or more applications. In some embodiments, the application store is a third party application store (e.g., an application store that is provided by another device, downloaded via a network, and/or read from a storage device). In some embodiments, the application is a third party application (e.g., an app that is provided by an application store, downloaded via a network, and/or read from a storage device). In some embodiments, the application controls the first computer system to perform the methods 400, 450, and 500 by calling an application programming interface (API) provided by the system process using one or more parameters.

In some embodiments, at least one API is a software module (e.g., a collection of computer-readable instructions) that provides an interface that allows a different set of instructions (e.g., API calling instructions) to access and use one or more functions, methods, procedures, data structures, classes, and/or other services provided by a set of implementation instructions of the system process. The API can define one or more parameters that are passed between the API calling instructions and the implementation instructions.

As described above, in some embodiments, the application controls the first computer system to perform the methods 400, 450, and 500 by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, a search API, and/or image processing API.

In some embodiments, the API 90 defines a first API call that can be provided by API calling instructions 80, where the definition for the first API call specifies the following call parameters: at least one unstructured query (e.g., text that is input by a user, text that is transcribed from a voice input provided by a user, text that is derived from information associated with a selection of one or more data objects, etc.).

In some embodiments, the API 90 defines a first API call response that can be provided to the application by API calling instructions 80, where the first API call response includes filtered results that are associated with, correspond to, etc., the unstructured query.

In some embodiments, the set of implementation instructions is a system software module (e.g., a collection of computer-readable instructions) that is constructed to perform an operation in response to receiving an API call via the API. In some embodiments, the set of implementation instructions is constructed to provide an API response (via the API) as a result of processing an API call. In some embodiments, the set of implementation instructions is included in the device (e.g., 50) that runs the application. In some embodiments, the set of implementation instructions is included in an electronic device that is separate from the device that runs the application.

Turning now to FIG. 4A, according to some embodiments, the method 400 can be performed by a media playback application, a search application, etc.—referred to within the context of FIG. 4A as the “application”-executing on a client computing device 102. As shown in FIG. 4A, the method 400 begins at step 402, where the application obtains an unstructured query from a user of the client computing device 102 (e.g., as described above in conjunction with FIGS. 2A-2N). At step 404, the application, in response to obtaining the unstructured query, provides the unstructured query to an operating system (OS) executing on the client computing device 102 (e.g., as described above in conjunction with FIGS. 2A-2N).

At step 406, the application, in response to providing the unstructured query to the OS, receives filtered results associated with the unstructured query, where: (1) a first large language model (LLM) produces a plurality of structured queries based on the unstructured query (e.g., as described above in conjunction with FIGS. 2A-2N), (2) each structured query of the plurality of structured queries is provided to respective one or more knowledge sources that are selected based on at least one aspect of the structured query and provide respective results (e.g., as described above in conjunction with FIGS. 2A-2N), and (3) the results are aggregated and filtered by a second LLM to generate the filtered results (e.g., as described above in conjunction with FIGS. 2A-2N).

At step 408, the application, in response to receiving the filtered results, performs at least one action associated with the filtered results (e.g., as described above in conjunction with FIGS. 2A-2N).

Turning now to FIG. 4B, according to some embodiments, the method 450 can be performed by a media playback application, a search application, etc.—referred to within the context of FIG. 4B as the “application”-executing on a client computing device 102. As shown in FIG. 4B, the method 450 begins at step 452, where the application, in response to providing an unstructured query to an operating system (OS) executing on the client computing device 102, obtains filtered results, where the filtered results include, for each result of the filtered results, a respective explanation as to why the result is relevant to the unstructured query (e.g., as described above in conjunction with FIGS. 2A-2N and FIGS. 3A-3M).

At step 404, the application generates a user interface that displays, for at least one result of the filtered results, (1) at least one first affordance that includes information associated with the result, and (2) at least one second affordance that, when selected, causes the application to display the respective explanation (e.g., as described above in conjunction with FIGS. 2A-2N and FIGS. 3A-3M).

Turning now to FIG. 5, according to some embodiments, the method 500 can be performed by a media playback application, a search application, etc.—referred to within the context of FIG. 5 as the “application”-executing on a client computing device 102. As shown in FIG. 5, the method 500 begins at step 502, where the application obtains an unstructured query from a user of the client computing device (e.g., as described above in conjunction with FIGS. 3A-3M).

At step 504, the application, in response to obtaining the unstructured query, provides the unstructured query to an operating system (OS) executing on the client computing device 102 (e.g., as described above in conjunction with FIGS. 3A-3M).

At step 506, the application, in response to providing the unstructured query to the OS, receives filtered results associated with the unstructured query, where: (1) the filtered results are generated using a first large language model (LLM) that produces a query understanding object, where the query understanding object includes a plurality of tasks, and each task of the plurality of tasks includes a respective category and respective one or more properties (e.g., as described above in conjunction with FIGS. 3A-3M), (2) each task of the plurality of tasks is (i) used to identify, based on the respective category and the respective one or more properties, respective one or more knowledge sources to produce respective results for the task, and (ii) provided to the respective one or more knowledge sources to produce the respective results (e.g., as described above in conjunction with FIGS. 3A-3M), and (3) the results are aggregated and filtered by a second LLM to produce filtered results (e.g., as described above in conjunction with FIGS. 3A-3M).

At step 508, the application, in response to receiving the filtered results, performs at least one action associated with the filtered results (e.g., as described above in conjunction with FIGS. 3A-3M).

FIG. 6 illustrates a detailed view of a computing device 600 that can be used to implement the various components described herein, according to some embodiments. In particular, the detailed view illustrates various components that can be included in the client computing device 102, the server computing device 106, the knowledge sources 118, and so on, described above in conjunction with FIG. 1.

As shown in FIG. 6, the computing device 600 can include a processor 602 that represents a microprocessor or controller for controlling the overall operation of computing device 600. The computing device 600 can also include a user input device 608 that allows a user of the computing device 600 to interact with the computing device 600. For example, the user input device 608 can take a variety of forms, such as a button, keypad, dial, touch screen, audio input interface, visual/image capture input interface, input in the form of sensor data, etc. Furthermore, the computing device 600 can include a display 610 (screen display) that can be controlled by the processor 602 to display information to the user. A data bus 616 can facilitate data transfer between at least a storage device 640, the processor 602, and a controller 613. The controller 613 can be used to interface with and control different equipment through an equipment control bus 614. The computing device 600 can also include a network/bus interface 611 that couples to a data link 612. In the case of a wireless connection, the network/bus interface 611 can include a wireless transceiver.

The computing device 600 also includes a storage device 640, which can comprise a single disk or a plurality of disks (e.g., SSDs), and includes a storage management module that manages one or more partitions within the storage device 640. In some embodiments, storage device 640 can include flash memory, semiconductor (solid state) memory or the like. The computing device 600 can also include a Random-Access Memory (RAM) 620 and a Read-Only Memory (ROM) 622. The ROM 622 can store programs, utilities, or processes to be executed in a non-volatile manner. The RAM 620 can provide volatile data storage, and stores instructions related to the operation of the computing devices described herein.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A method, comprising, at a server computing device:
receiving an unstructured query from a client computing device;
providing the unstructured query to a first large language model (LLM) to produce a plurality of structured queries;
for each structured query of the plurality of structured queries:
identifying, based on at least one aspect of the structured query, respective one or more knowledge sources to produce respective results for the structured query, and
providing the structured query to the respective one or more knowledge sources to produce the respective results;
aggregating the results to produce aggregated results;
providing the aggregated results to a second LLM to produce filtered results; and
causing the client computing device to display at least a portion of the filtered results.

2. The method of claim 1, further comprising, prior to causing the client computing device to display the at least a portion of the filtered results:
providing the filtered results to a third LLM to assign, to each result of one or more results of the filtered results, a respective explanation as to why the result is relevant to the unstructured query.

3. The method of claim 1, further comprising, prior to causing the client computing device to display the at least a portion of the filtered results:
providing the filtered results to a third LLM to assign, to the filtered results, one or more words that summarize the filtered results.

4. The method of claim 1, further comprising, prior to causing the client computing device to display the at least a portion of the filtered results:
providing the filtered results to at least one artificial intelligence (AI) engine to generate media content that pertains to the filtered results, wherein the media content comprises image content, audio content, and/or video content.

5. The method of claim 1, wherein the one or more knowledge sources include:
at least one web search engine;
at least one question and answer (Q&A) knowledge source;
at least one knowledge graph;
at least one approximate nearest-neighbor (ANN) index;
at least one other LLM; or
some combination thereof.

6. The method of claim 1, wherein:
at least one structured query of the plurality of structured queries includes at least one placeholder value; and
at least one respective result for at least one other structured query of the plurality of structured queries is assigned to the at least one placeholder value.

7. The method of claim 1, wherein:
the unstructured query is paired with at least one conversation history that is associated and received from the client computing device;
the at least one conversation history is provided to:
the first LLM along with the unstructured query, and/or
the second LLM along with the filtered results; and
the at least one conversation history is forgotten by the server computing device in conjunction with providing the aggregated results to the second LLM to produce filtered results.

8. A method, comprising, at a server computing device:
receiving an unstructured query from a client computing device;
providing the unstructured query to a first large language model (LLM) to produce a query understanding object, wherein the query understanding object includes a plurality of tasks, and each task of the plurality of tasks includes a respective category and respective one or more properties;
for each task of the plurality of tasks:
identifying, based on the respective category and the respective one or more properties, respective one or more knowledge sources to produce respective results for the task, and
providing the task to the respective one or more knowledge sources to produce the respective results;
aggregating the results to produce aggregated results;
providing the aggregated results to a second LLM to produce filtered results; and
causing the client computing device to display at least a portion of the filtered results.

9. The method of claim 8, further comprising, prior to causing the client computing device to display the at least a portion of the filtered results:
providing the filtered results to a third LLM to assign, to each result of one or more results of the filtered results, a respective explanation as to why the result is relevant to the unstructured query,
providing the filtered results to the third LLM to assign, to the filtered results, one or more words that summarize the filtered results, or
some combination thereof.

10. The method of claim 8, further comprising, prior to causing the client computing device to display the at least a portion of the filtered results:
providing the filtered results to at least one artificial intelligence (AI) engine to generate media content that pertains to the filtered results, wherein the media content comprises image content, audio content, and/or video content.

11. The method of claim 8, wherein:
the respective category of a given task corresponds to album information, artist information, beats per minute (BPM) information, composer information, conductor information, content group information, copyright information, cover art information, disk number information, encoding information, genre information, initial key information, mood information, original artist information, publisher information, release date information, subtitle information, track title information, track number information, and/or year information; and
the respective one or more properties of the given task function as values for the respective category of the given task.

12. The method of claim 8, wherein:
the unstructured query is paired with at least one conversation history that is associated and received from the client computing device;
the at least one conversation history is provided to:
the first LLM along with the unstructured query, and/or
the second LLM along with the filtered results; and
the at least one conversation history is forgotten by the server computing device in conjunction with providing the aggregated results to the second LLM to produce filtered results.

13. A method, comprising, by an application executing on a client computing device:
obtaining an unstructured query from a user of the client computing device;
in response to obtaining the unstructured query, providing the unstructured query to an operating system (OS) executing on the client computing device;
in response to providing the unstructured query to the OS, receiving filtered results associated with the unstructured query, wherein:
a first large language model (LLM) produces a plurality of structured queries based on the unstructured query,
each structured query of the plurality of structured queries is provided to respective one or more knowledge sources that are selected based on at least one aspect of the structured query and provide respective results, and
the results are aggregated and filtered by a second LLM to generate the filtered results; and
in response to receiving the filtered results, performing at least one action associated with the filtered results.

14. The method of claim 13, wherein the filtered results are further provided to:
a third LLM to assign, to each result of one or more results of the filtered results, a respective explanation as to why the result is relevant to the unstructured query,
the third LLM to assign, to the filtered results, one or more words that summarize the filtered results,
at least one artificial intelligence (AI) engine to generate media content that pertains to the filtered results, wherein the media content comprises image content, audio content, and/or video content, or
some combination thereof.

15. The method of claim 13, wherein:
at least one structured query of the plurality of structured queries includes at least one placeholder value; and
at least one respective result for at least one other structured query of the plurality of structured queries is assigned to the at least one placeholder value.

16. The method of claim 13, wherein:
the unstructured query is paired with at least one conversation history that is associated the user;
the at least one conversation history is provided to:
the first LLM along with the unstructured query, and/or
the second LLM along with the filtered results; and
the at least one conversation history is forgotten by the client computing device in conjunction with providing aggregated results to the second LLM to produce filtered results.

17. A method, comprising, by an application executing on a client computing device:
in response to providing an unstructured query to an operating system (OS) executing on the client computing device, obtaining filtered results, wherein the filtered results include, for each result of the filtered results, a respective explanation as to why the result is relevant to the unstructured query; and
generating a user interface that displays, for at least one result of the filtered results, (1) at least one first affordance that includes information associated with the result, and (2) at least one second affordance that, when selected, causes the application to display the respective explanation.

18. The method of claim 17, wherein:
the filtered results further include a first description of knowledge sources from which the filtered results were gathered, and a second description of information on which the filtered results are based, and
the user interface further includes at least one third affordance that, when selected, causes the application to display the first description, the second description, or some combination thereof.

19. A method, comprising, by an application executing on a client computing device:
obtaining an unstructured query from a user of the client computing device;
in response to obtaining the unstructured query, providing the unstructured query to an operating system (OS) executing on the client computing device;
in response to providing the unstructured query to the OS, receiving filtered results associated with the unstructured query, wherein:
the filtered results are generated using a first large language model (LLM) that produces a query understanding object, wherein the query understanding object includes a plurality of tasks, and each task of the plurality of tasks includes a respective category and respective one or more properties,
each task of the plurality of tasks is (1) used to identify, based on the respective category and the respective one or more properties, respective one or more knowledge sources to produce respective results for the task, and (2) provided to the respective one or more knowledge sources to produce the respective results, and
the results are aggregated and filtered by a second LLM to produce filtered results; and
in response to receiving the filtered results, performing at least one action associated with the filtered results.

20. The method of claim 19, wherein:
the respective category of a given task corresponds to album information, artist information, beats per minute (BPM) information, composer information, conductor information, content group information, copyright information, cover art information, disk number information, encoding information, genre information, initial key information, mood information, original artist information, publisher information, release date information, subtitle information, track title information, track number information, and/or year information; and
the respective one or more properties of the given task function as values for the respective category of the given task.
